(19) United States
(12) Patent Application Publication
(10) Pub. No.: US 2007/0219916 A1
(43) Pub. Date: Sep. 20, 2007

(54) Systems and methods for tracking and verifying the authenticity of an item

(76) Inventor: Michael Lucas, Calabasas, CA (US)

Correspondence Address: NATH & ASSOCIATES, 112 South West Street, Alexandria, VA, 22314, US

(21) Appl. No.: 11/711,884

(22) Filed: Feb. 28, 2007

Related U.S. Application Data
(63) Continuation-in-part of application No. 10/873,183, filed on Jun. 23, 2004.
Application No. 10/873,183 is a continuation of application No. 09/799,879, filed on Mar. 7, 2001, now Pat. No. 6,996,538.
(60) Provisional application No. 60/187,389, filed on Mar. 7, 2000.

(51) Int. Cl. G06F 17/00

(52) U.S. Cl. 705/58

(57) ABSTRACT

The inventive subject matter relates to novel systems and methods for tracking and/or verifying the authenticity of items, such as in commerce or society.

This application is a continuation-in-part of U.S. patent application Ser. No. 10/873,183, filed Jun. 23, 2004, which is a continuation of U.S. patent application Ser. No. 09/799,879, filed Mar. 7, 2001, which claims the benefit of U.S. Provisional Patent Application No. 60/187,389, filed Mar. 7, 2000. Further, this application claims the benefit of U.S. Provisional Patent Application No. 60/776,955, filed Feb. 28, 2006; and 60/786,692, filed Mar. 29, 2006. The contents of each of the applications listed above is hereby incorporated by reference in its entirety.

### BACKGROUND OF THE INVENTIVE SUBJECT MATTER

1. Field of the Inventive Subject Matter

The inventive subject matter relates to novel systems and methods for tracking and/or verifying the authenticity of items, such as in commerce or society.

2. Background

In today's commercial environment, consumers, business buyers, and regulators have a need for information relating to the origin, chain of custody or possession, and/or authenticity of a large variety of commercial items. Similarly, in other aspects of society such as government and government services, there is also a need for information relating to the origin, chain of custody or possession, and/or authenticity of tangible objects and things.

Although the inventive subject matter is not so limited, and applies to any item, such as in commerce or society, for which tracking and authentication are of interest to businesses, business customers, and members of the public, exemplary of a particularly critical need for tracking and authenticity verification is the pharmaceutical supply chain. In February 2006, it had been estimated by the World Health Organization (“WHO”) that 10% of the global trade in medicines involves counterfeit items. More recently in November 2006, WHO stated in a press release that “The latest estimates . . . show that more than 30 percent of medicines in some areas of Latin America, Southeast Asia and sub-Saharan Africa are counterfeit,” citing statistics jointly compiled with other international organizations. In relatively richer emerging economies, the figure was around 10 percent, and in many of the now independent republics of the former Soviet Union the rate of counterfeiting was as high as 20 percent. WHO also estimated that the illegal trade worldwide was worth more than $30 billion a year, which is between 5 and 8 percent of the total annual market for medicines.

Further, counterfeit medicines may account for as much as about 50 percent of those sold on the Internet by illegal operators, as opposed to legal pharmaceutical companies that offer drugs at reduced prices but demand medical prescriptions before fulfilling Internet orders.

In this context, counterfeit medicines can harm patients by failing to treat serious conditions, can provoke drug resistance, and in some cases can kill. Particularly insidious is the fact that counterfeit medicines can and do dupe sick people into believing they are taking something which will make them well, when it may instead make them sicker or even kill them. Counterfeit medicines are part of a broader phenomenon of substandard pharmaceuticals. The difference is that they are deliberately and fraudulently mislabeled with respect to identity and/or source. These products mostly have no therapeutic benefit; they can cause drug resistance and death.

Trade in counterfeits is extremely lucrative, thus making it more attractive to criminal networks. A report released by the Center for Medicines in the Public Interest projects counterfeit drug sales to reach $75 billion in 2010, a 92% increase from 2005.

The presence of such counterfeit drugs is more prevalent in countries with weak drug regulation control and enforcement. However, no country is immune to the problem. Reports from the pharmaceutical industry and governments clearly indicate that the methods and channels used by counterfeiters are becoming more sophisticated, making detection more difficult. Measures for combating counterfeit medicines so far have included support to under-resourced drug regulatory authorities; simple, easily interpretable and cheap markers of authenticity such as bar coding; transnational surveillance for counterfeit and substandard drugs; and education of patients, healthcare workers, and pharmacists.

Despite these efforts, the steps and technology are not yet available to guarantee the availability of quality-assured essential drugs.

Similarly, in the exemplary field of auto parts supply, the magnitude of counterfeit parts in the aftermarket and other automotive market segments continues to grow. It has been estimated that counterfeiting costs the automotive industry $12 billion annually, which correlates to a loss of about 200,000 jobs. One industry trade representative, the Motor & Equipment Manufacturers Association (MEMA), has been working with U.S. Immigration and Customs Enforcement, a division of the Department of Homeland Security, to reinforce the emphasis on curtailing imported counterfeit goods, and has been working with Congress to develop and introduce a bill that strengthens current anti-counterfeiting laws. Nevertheless, no solution to these problems has been provided to date through these actions.

In order to be admissible in court, physical evidence which relates to the issues in the case must be verifiably authentic in order to avoid possible attack by the parties and exclusion from consideration. Thus, for example, in a criminal case, an identifiable person must always have the physical custody of a piece of evidence. In practice, this means that a police officer or detective will document the collection and take charge of a piece of evidence, handing it over to an evidence clerk for storage in a secure place. These transactions, and every succeeding transaction between the collection of the evidence and its appearance in court, must be completely documented chronologically in order to withstand legal challenges to the authenticity of the evidence.

The current technology for establishing an evidentiary chain of custody generally involves keeping records on paper for each transaction involving each item of evidence; few local databases and no unified database among evidence handling facilities exists. The current system is both cumbersome and prone to errors.

Counterfeiting of tickets to events such as concerts, theater, film, sports, and other performances is a growing problem. With the advent of instant, on-line ticketing, it has also become possible for anyone with a computer and printer to produce fraudulent event tickets. This is a serious problem for event producers, ticket sellers, and consumers, as there is often a significant emotional attachment between performers or athletes, and their fans. When two people hold tickets to the same seat for the same event, the situation is difficult for all involved and may ultimately damage goodwill and limit consumer interest in attending live events. Similarly, there is a desire to maintain the restrictions on restricted use tickets such as student, player, or VIP tickets.

The inventive subject matter addresses the deficiencies in the prior art by providing a system for tracking and/or verifying the authenticity of individual items, such as in commerce or society.

### SUMMARY OF THE INVENTIVE SUBJECT MATTER

The present inventive subject matter relates to a method for tracking, authenticating, or tracking and authenticating an object through a chain of custody, comprising the steps of:

(a) providing a database having client software and residing on at least one storage medium in at least one computer;

(b) collecting and storing in said database at least the following data:

information relating to said object,

information associating said object to an identifier code which is unique to said object, and

information relating to user permissions or roles permitting a user to have access to some or all of the information in said database;

(c) providing a system for detecting said unique identifier code at multiple locations in said chain of custody;

(d) tracking said object in said database by detecting said unique identifier code at each time event in which said object is transferred from one party in the chain of custody to another, or from one location in the chain of custody to another, and collecting and storing the identity of each party who takes custody of said object at each time event; and

(e) providing access to information establishing the chain of custody of said object.

The inventive subject matter further relates to a system for tracking, authenticating, or tracking and authenticating an object through a chain of custody, comprising the following elements, operably connected:

(a) a computer having a storage medium;

(b) a database residing on said storage medium, in which at least the following data is stored:

information relating to said object,

information associating said object to an identifier code which is unique to said object, and

information relating to user permissions or roles permitting a user to have access to some or all of the information in said database;

(c) client software residing on said storage medium which provides an interface to said database, wherein:

(i) said client software identifies users and allows users to be classified into groups, and wherein permissions or roles are assigned to such groups,

(ii) said client software tracks said object in said system by detecting said unique identifier code at each time event in which said object is transferred from one party in the chain of custody to another, or from one location in the chain of custody to another, and collects and stores the identity of each party who takes custody of said object at each time event, and

(iii) said client software provides access to information establishing the chain of custody of said object.

### BRIEF DESCRIPTION OF THE DRAWINGS

FIG. 1 is a drawing which depicts an exemplary system, using an alphanumeric matrix, for specially coding and tracking pharmaceutical products at the levels of: single item; box or package; carton; and pallet, according to one aspect of the inventive subject matter.

FIG. 2 is a drawing which depicts an exemplary system, using detection of a unique identifier located in or on each item, for specially coding and tracking pharmaceutical products at the levels of: single item; box or package; carton; and pallet, according to another aspect of the inventive subject matter.

FIG. 3 is a drawing which depicts an exemplary system, using an alphanumeric matrix, for specially coding and tracking ammunition at the levels of: single item; box or package; carton; and pallet, according to one aspect of the inventive subject matter.

FIG. 4 is a drawing which depicts an exemplary system, using detection of a unique identifier located in or on each item, for specially coding and tracking ammunition at the levels of: single item; box or package; carton; and pallet, according to another aspect of the inventive subject matter.

FIG. 5 is a drawing which depicts exemplary commercial channels in which a unique code is applied to a commercial item by, or immediately upon leaving the possession of, a product manufacturer, and is available for item tracking and/or authenticity verification as the product traverses the course of commerce to a customer, either directly or through intermediaries such as supplier(s), distributor(s), and/or retailer(s), according to one aspect of the inventive subject matter.

FIG. 6 is a drawing which depicts an exemplary system, using a unique identity code located in or on each item, for specially coding and tracking pharmaceutical products at the levels of: single item; box or package; carton; and pallet, according to another aspect of the inventive subject matter.

FIG. 7 is a drawing which depicts an exemplary system, using detection of a unique identifier located in or on each item, for specially coding and tracking pharmaceutical products at the levels of: single item; box or package; carton; and pallet, according to another aspect of the inventive subject matter.

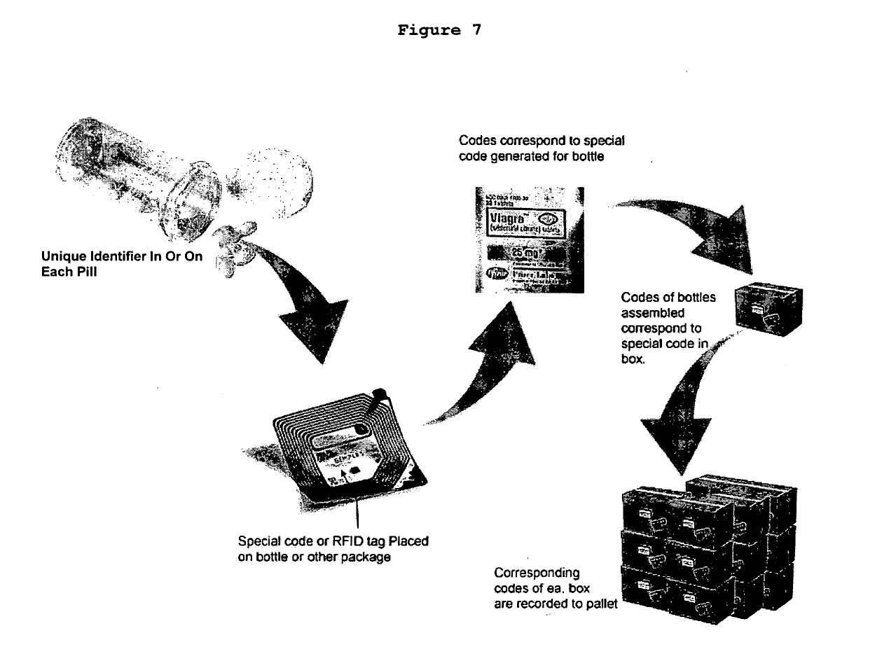

FIG. 8 is a drawing which depicts an exemplary evidence tracking and authentication system, according to one aspect of the inventive subject matter.

### DETAILED DESCRIPTION OF THE INVENTIVE SUBJECT MATTER

### Definitions

The term “seller” as used herein refers to any one or more of commercial item manufacturers, suppliers, distributors, retailers, and other sellers such as private party individuals purporting to sell an commercial item.

The term “commercial item” as used herein refers to goods that are held for sale by a person or entity. Exemplary commercial item packaging units of increasing quantities include a single item; a box or package; a carton; a pallet; and a shipping container. The specific quantity designated as a unit for a commercial item is determined by, for example, the size, cost, and packaging of the particular asset.

The terms “object” and “item” as used herein refer to tangible things which are not necessarily held for sale, but are to be tracked and/or authenticated. As used herein, a “commercial item” is within a subset of “objects” or “items” generally.

“Enterprise” as used herein refers broadly to a purposeful or industrious undertaking. The term encompasses not only business undertakings, but also includes, for example, such non-business undertakings as managing the assets of a family or a home.

“User” as used herein refers to a person, machine, or mechanized process which manipulates a commercial item during the course of commerce of the commercial item.

“Genetic fingerprinting” or “DNA fingerprinting” as used herein refers to the process of distinguishing between individual plants or animals using DNA samples. Techniques for conducting genetic fingerprinting are routine for skilled artisans in fields such as forensics and molecular biology, and are well known. DNA fingerprinting methods include, without limitation, RFLP analysis, PCR analysis, AmpFLP analysis, STR analysis, Y-chromosome analysis, and mitochondrial DNA analysis.

The term “expiration date” as used herein refers to true product expiration dates, product sell-by dates, component life-cycle expiration dates, and the like.

The term “a party in the chain of custody” as used herein refers to any person or entity which comes into physical possession of an object to be tracked or authenticated. The term is intended to encompass all such persons, including without limitation multiple employees of a single company. In this context, the “chain of custody” of an item as used herein refers to the documentary trail showing the custody, control, transfer, seizure, analysis, and/or disposition of an object.

### THE INVENTIVE SUBJECT MATTER

The inventive subject matter relates to novel systems and methods for tracking and/or verifying the authenticity, or e-pedigree, of items, such as in commerce or society.

Consumers, manufacturers, suppliers, distributors, retailers, and others in the chain of commerce of a commercial item can benefit from assurances that the item is genuine, and has not been diverted from legitimate channels and/or adulterated. The chain of commerce of a medication is instructive and exemplary of the benefits provided by the inventive subject matter.

The counterfeiting of currency and consumer products are common problems that plague governments and manufacturers around the world. The counterfeiting of medications is a particularly insidious practice. Drug counterfeiters not only defraud consumers, they also deny ill patients the therapies that can alleviate suffering and save lives. In some countries the counterfeiting of drugs is endemic, with some patients having a better chance of getting a counterfeit medicine than a real one. In many more countries, counterfeit drugs are common.

In the United States, it has been believed that a relatively comprehensive system of laws, regulations, and enforcement by Federal and state authorities has kept drug counterfeiting instances low, so that Americans can have a reasonable degree of confidence in the drugs they obtain through legal channels. For example, the Prescription Drug Marketing Act of 1987 requires wholesale distributors to provide documentation of the chain of custody of drug products throughout the distribution system.

In recent years, however, even the U.S. has seen growing evidence of efforts by increasingly well-organized counterfeiters, backed by increasingly sophisticated technologies and criminal operations, to profit from drug counterfeiting at the expense of the healthcare industry and medical patients.

To respond to this emerging threat, the Food and Drug Administration (“FDA”) formed a Counterfeit Drug Task Force in July 2003. That group received extensive comment from security experts, Federal and state law enforcement officials, technology developers, manufacturers, wholesalers, retailers, consumer groups, and the general public on a very broad range of ideas for deterring counterfeiters. Those comments reinforced the need for FDA and others to take action in multiple areas to create a comprehensive system of modern protections against counterfeit drugs. In a 2004 report, FDA declared that track-and-trace technologies, such as RFID, would be in widespread use in the drug supply chain by 2007. Agency officials hoped that if widely adopted, RFID could create a de facto electronic pedigree that would document the sale of a drug product from the place of manufacture through the U.S. drug supply chain to the final dispenser. This hope has not, to date, been borne out and there remains a great need for an effective system for maintaining the integrity of the drug supply chain and avoiding counterfeiting.

### THE INVENTIVE METHODS

The inventive systems, methods, and implementing hardware and software address these growing societal problems. Thus, the inventive subject matter relates to a method for tracking, authenticating, or tracking and authenticating an object through a chain of custody, comprising the steps of:

(a) providing a database having client software and residing on at least one storage medium in at least one computer;

(b) collecting and storing in said database at least the following data:

information relating to said object,

information associating said object to an identifier code which is unique to said object, and

information relating to user permissions or roles permitting a user to have access to some or all of the information in said database;

(c) providing a system for detecting said unique identifier code at multiple locations in said chain of custody;

(d) tracking said object in said database by detecting said unique identifier code at each time event in which said object is transferred from one party in the chain of custody to another, or from one location in the chain of custody to another, and collecting and storing the identity of each party who takes custody of said object at each time event; and

(e) providing access to information establishing the chain of custody of said object.

In one aspect of the inventive subject matter, the method further comprising collecting and storing the identity of each said party who relinquishes custody of said object at each time event.

In another aspect of the inventive subject matter, the method further comprising collecting and storing the location of each transfer of custody of said object at each time event.

In a further aspect of the inventive subject matter the method further comprising the steps of: collecting and storing in said database information relating to the quantity of objects of a particular type; and aggregating said tracking data for a plurality of objects of a particular type.

In an alternate aspect of the inventive subject matter, the method further comprising packaging a plurality of objects into a first-level package and marking said first-level package with a unique first-level package identifier; and tracking said unique first-level package identifier instead of or in addition to said object identifier.

In a preferred embodiment, the method further comprising packaging a plurality of first-level packages into a second-level package and marking said second-level package with a unique second-level package identifier; and tracking said unique second-level package identifier instead of or in addition to said object identifier and/or said first-level package identifier.

In another aspect, the step immediately above can be repeated one or more additional times. For example, a plurality of first-level packages is optionally further packaged into a second-level package; a plurality of second-level packages is optionally further packaged into a third-level package; a plurality of third-level packages is optionally further packaged into a fourth-level package; and so forth, wherein at each level of packaging, a new package encompasses a plurality of packages from the preceding packaging step.

Thus, in one exemplary embodiment, a first-level package comprises a bottle or box of individual items; a second-level package comprises a box or carton of first-level packages; a third-level package comprises a pallet of second-level packages; and a fourth-level package comprises a truck or shipping container of third-level packages.

In yet another aspect of the inventive subject matter, said unique identifier code is assigned by the original source of said object.

In another aspect of the inventive subject matter, said unique identifier code is assigned an associated expiration date.

In a further aspect of the inventive subject matter, access to information establishing the chain of custody of said object is provided by generating a chain of custody report.

In an alternate aspect of the inventive subject matter, access to information establishing the chain of custody of said object is provided by generating one or more alert notifications.

In a preferred embodiment, said one or more alert notifications is selected from the group consisting of an unauthorized party or user alert notification, an unauthorized location alert notification, an excess quantity alert notification, an insufficient quantity alert notification, a past expiration date alert notification, and combinations thereof.

In another aspect of the inventive subject matter, the inventive systems and methods are configured or executed to provide positive, negative, or preferably both positive and negative event notifications relating to a match, or lack thereof, between the identifiers detected during a scan for the identifiers and the identifiers expected to be associated, based on the data recorded in said database. Thus, the systems and methods would provide a notification to a user that an item or package is missing from the set of detected identifiers; that an unexpected item or package is found in the set of detected identifiers; or that an invalid, i.e. unassigned identifier is found in the set of detected identifiers.

As a security measure in a preferred embodiment of the inventive subject matter, the original source of an item to be tracked and/or authenticated, for example a parts manufacturer, a drug producer, a produce grower, a cattle rancher, or a crime scene investigator, assigns or associates a unique identifier code to the item. Such unique identifiers include bar codes, RFID codes, alpha-numeric matrices, molecular signatures, DNA fingerprints, and the like.

The unique identifier code and data about the associated item are recorded, placed in a database, optionally and preferably associated with a first time and/or location, and optionally associated with an expected future second time and/or location such as a transport destination. Each code may have a time limit such as an expiration date, which prevents re-use of the code after its expected use. Each item is tracked by scanning for the code, either in association with events associated with shipping or receipt, or in association with a periodic scan such as an in-transit, warehouse, or stock inventory check.

Event notifications are preferably generated upon comparing first time and/or location data with second time and/or location data and identifying, for example, excess or insufficient quantities, unexpected time and location association, or unknown or unexpected code(s). Such event notifications are expected in many or all cases to be associated with loss, diversion, theft, and/or counterfeiting of tracked items.

In one aspect, the inventive subject relies upon unique identifier tagging of individual commercial items, in this example a single dose of a drug such as is found in an individual tablet, capsule, caplet, or pill, using a technique such as imprinting or casting each item with an alphanumeric matrix, or marking or implanting each item with an identifier, or “special code”, which is unique to the individual item.

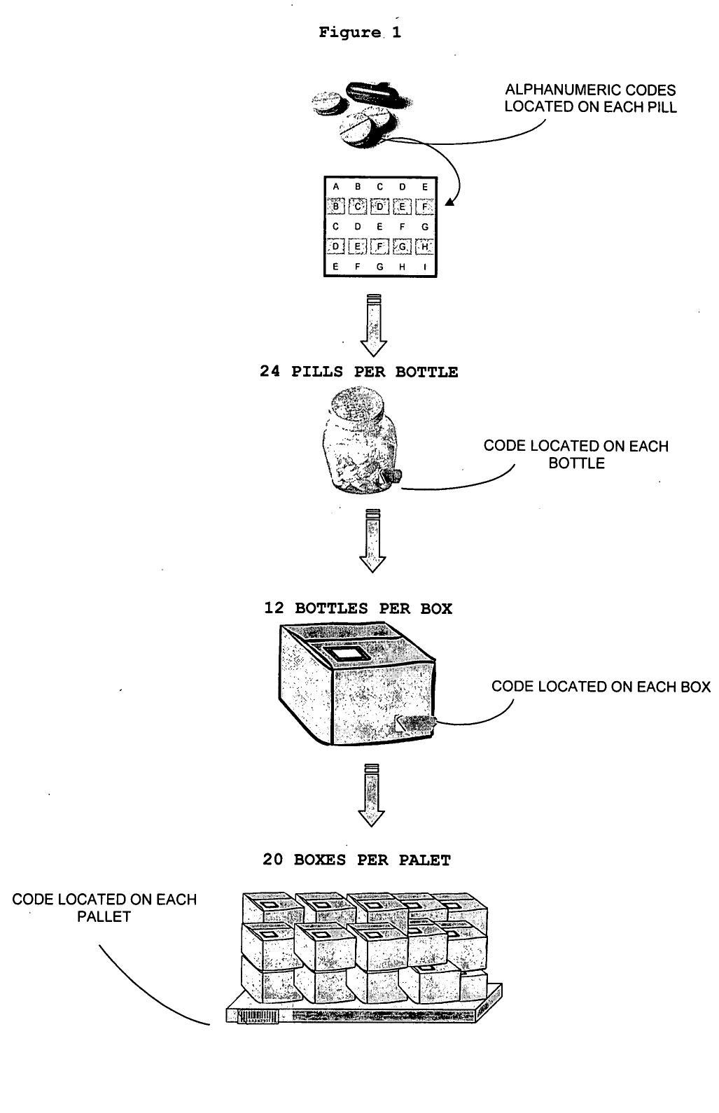

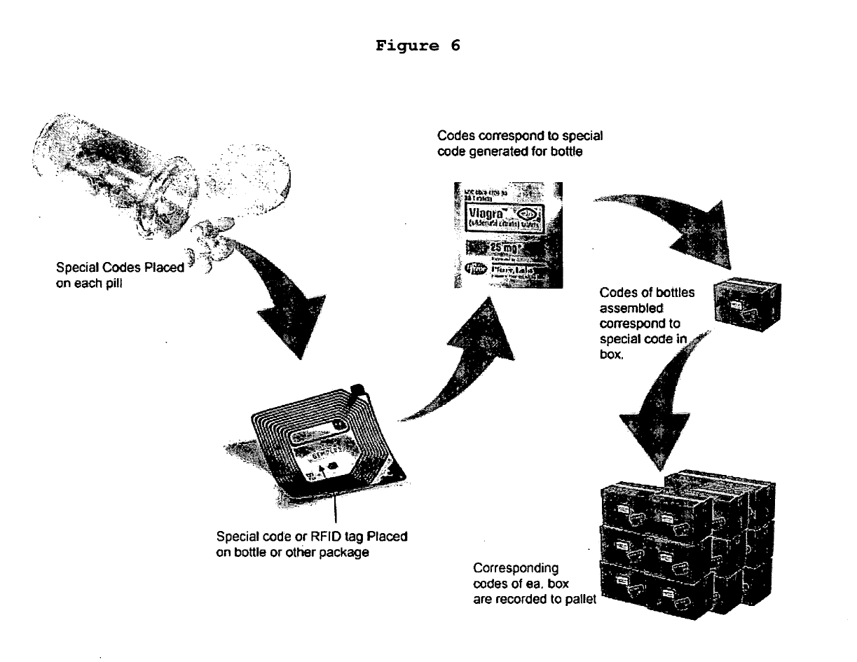

Larger item packaging units, such as a bottle, box, pallet, or shipping container, are similarly tagged with a separate unique identifier, such as a bar code or radio frequency identification (RFID) tag, and one or more database(s) are initiated and maintained to associate each population of unique identifiers at each packaging level with the unique identifier associated at higher and lower unit packaging levels. Thus, as shown in FIGS. 1, 2, and 6 for example, individuals pills are marked with a unique pill identifier, such as an alphanumeric matrix, which is then associated with a unique bottle identifier, such as a bar code, which is in turn associated with a unique box identifier such as a passive RFID tag, and which is in turn associated with a separate unique pallet identifier, such as an active RFID tag.

As will be apparent to a skilled artisan, the particular type of unique identifier to be used at each level of packaging may be selected from and varied between any one of several tagging technologies currently available, as described in part in the examples herein. Selection of the specific type of tagging for a particular item will depend on such factors as the size and composition of the product, the relative cost of an individual commercial unit and of each higher level of packaging, the cost of packaging in relation to the cost of the product, the risk of counterfeiting of the particular product, and so forth. A skilled artisan will recognize that selection of a specific type of tagging for a particular item can be freely modified between one or more of the specific tagging technologies described herein and other tagging technologies, both currently known and yet to be found.

In addition to tagging technologies, exemplary unique identifiers for specially coding items can also be based solely upon a unique physical characteristic of the item. For example, laser surface identification technology, which provides a unique molecular fingerprint, is discussed in greater detail below. Similarly, genetic fingerprinting, based on the DNA of a living thing such as a head of livestock, can also be used as a unique identifier.

Applicant expects that RFID tagging will provide the most cost-effective and cost-reducing benefits in such areas of inventory control, while also providing the ability to track and trace the movement of every item or package of items from production to disposition. Most importantly, the inventive systems and methods, particularly utilizing RFID technology wherever possible, will make counterfeiting of items ranging from auto parts to pharmaceuticals more difficult and/or less profitable.

A skilled artisan will recognize that an embodiment of the inventive subject matter can be, and preferably should be, implemented using a computer. In that case, the method is embodied as instructions that make up a program. The program may be stored on computer-readable media, such as floppy disks, optical discs such as compact discs, or fixed disks such as hard drives, and can be resident in memory, such as random access memory (RAM), read-only memory (ROM), firmware, or flash RAM memory. The program as software can then be executed on a computer to implement the method. The program, or portions of its execution, can be distributed over multiple computers in a network.

Alphanumeric matrices. It can be difficult to track a product from its source to its eventual use. Similarly, without any way for a consumer to determine who is producing a product, the legitimate manufacturer has no effective way to encourage customers to purchase a genuine article. The inventive subject matter thus provides for associating codes, preferably randomly assigned, with objects, either individual commercial items or packaged multiples thereof. The system accepts a previously assigned code or generates a new code for an item. The code is transmitted to a user, such as a manufacturer, who can mark the item with the code. The code and item identifier are associated with each other in a database or registry. Downstream users of the item can then make inquiries of the system to learn about the item, and/or to provide additional information about the item for the database.

In one embodiment, a code generator is responsible for generating codes, and optionally includes a random number generator, which is in turn responsible for generating random numbers. Random numbers are optionally used because any rational scheme to enumerate or label products invites someone to counterfeit the product using the same labeling scheme. If the identifier is a purely random code and there is no other information on the item, then counterfeiting the product is very difficult to impossible depending on the client's selected level of record-keeping or the number of items counterfeited.

In one embodiment, the code generator generates codes in base-35. Using base-35 allows codes to be written easily using alphanumeric characters comprising the alphabet (25 characters except the letter “O”) and the digits 0-9. This enables codes with very large values to be written using relatively few characters. A skilled artisan will recognize that other bases or other graphical symbols can be used. In addition, non-alphabetic graphical symbols can be used, although using known alphabets allows for easy input as a human inquiry, with a keyboard, by handwriting, or orally.

In one embodiment, the generated codes have a number of characters that is a perfect square: for example, 16, 25, or 36 characters, corresponding to 4×4, 5×5, and 6×6 matrices respectively, which can be printed in square blocks, and which make for ease of use. However, a skilled artisan will recognize that the reason for such code lengths is purely cosmetic. Codes can be of any length, and can be printed in any configuration desired. In addition, codes of different lengths can be generated for different items, depending on the desired application. Thus, a code assigned to a t-shirt might have 16 characters, a code assigned to an auto part might have 25 characters, and a code assigned to an individual medication pill might have 36 characters.

The codes that are generated are not only random, but also have no meaning in and of themselves, both before and after generation. Thus, other than the association for the particular commercial item, there is no relationship between the item and the code. Thus, while one particular code might represent one item, the next number might represent an entirely different item, or in all probability, there would be a very large gap until the next number used. Each item of a particular type would preferably have an entirely distinct and independent number from others of the same type, and even of the same batch. Thus, two pills from the same production run would preferably not have sequential identifiers. In such an instance, the only meaning is found in the association between the code and the item.

When the codes are randomly generated, a third party cannot determine any useful information about products and production systems. In contrast, serial identification methods make it easy for third parties to glean information about production: the code is usually easily cracked. The random nature of the codes encourages a level of trust by companies in the registry.

The associations between codes and items are stored in a registry, such as one or more database(s). Such database(s) can be any, or all, varieties of database: e.g., relational, item-oriented, etc. The database(s) can also be distributed: that is, part of a LAN, SAN, or WAN if desired, and described as comprising “one or more” database(s) or as the singular, cumulative “database” herein. Redundancy, to protect against the accidental loss of data, can also be implemented. The database(s) can perform all typical database operations: adding entries to the database, removing entries from the database, and searching the database for values.

In one embodiment, the database associates item identifiers, typically short descriptions of the items, with the codes. These descriptions can be assigned by the manufacturers of the items. In another embodiment, the stored value associated with the code in the database might be a URL or other identifying Internet address where the manufacturer maintains the data describing the item. In yet another embodiment, the database also stores additional information about the item. For example, the database can store detailed information about the item, such as when and where the item was produced, how many items were produced in the same product run, and so forth. In addition, a database entry can be linked to other database entries, indicating that there is some relationship between the linked items. A person skilled in the art will recognize that the term “link” here means only an association or cross-reference within the database, and would be interpreted broadly to encompass any way to cross-reference entries in the database.

The database can also flag information with different security levels. Certain information can be made available to anyone, whereas other information should be released only to parties having appropriate permissions or roles. For example, the production detail records of a drug are important to the manufacturer and to the FDA, but might not be important to a person inquiring about the drug, unless the person happens to have been prescribed the drug. Thus, when the pharmaceutical company or the FDA makes an inquiry about the drug, they can see the production history, but an ordinary person would not.

One functionality that is typically not offered by the database to general inquirers, although item manufacturers would preferably be able to use this feature, if offered, is text-based searching. That is, an user can search the database for a particular code, but not for a particular text string. This is to prevent counterfeiters from being able to conduct a text-based search to locate a code assigned to the items they want to counterfeit. If a counterfeiter has to randomly guess codes, he would be expected to run out patience long before he achieves any success. In this regard, it should be kept in mind that the counterfeiter needs to copy a valid code for the counterfeited item. A missing code, a code that was never issued, or a code assigned to an entirely different product would all immediately flag the association between item and code as invalid.

The reason the counterfeiter would be expected to fail in an attempt to find a valid code is a consequence of the mathematics of assigning codes. For example, selecting 16-character codes using base-35 arithmetic offers roughly 5×10²⁴ different codes. Using these assumptions, there are then about 10¹⁵ codes for each man, woman, and child alive today. Using 36-character codes, the number of possible codes increases to almost 4×10⁵⁵. And as it is estimated that there are only 10⁸² atoms in the entire universe, going to a 53-character code would provide enough codes to uniquely identify every atom in the universe.

With about 10¹⁵ codes per person available using 4×4 matrices and a base-35 character set, it is likely that only a very tiny fraction of the possible codes will ever be used. Simply guessing about a particular made-up number would be unlikely to successfully match anything. Even taking a systematic approach and entering one code every 10 seconds would require many years of entries to match anything, which would not necessarily be the item the inquirer was hoping for. Requiring a separate log-on/log-off session for each set of inquiries thereby inserts an essentially insurmountable time barrier to anyone seeking to profit from casual inquiry, even utilizing massive or automated inquiries to discover valid codes.

The unique code assignment system described above can optionally incorporate other security features, for example a code comparator for checking codes entered by a user; a verifier which checks, when a request for a new code comes in, whether the requester is in fact an authorized system user, such as the manufacturer of the product; and a notice function which informs an inquirer of the status of the provided code in the database.

A person skilled in the art will recognize that the codes can be printed using various techniques such as laser etching, stamping, printing, and the like.

The codes can be made as large or as small as desired. For example, a code can be printed using fairly large fonts for easy readability. Or the codes can be printed small, so that they are not easily located or are safely tucked away in a convenient spot.

The codes can be placed anywhere on the object desired. For example, for a capsule of medication, the codes can be stamped or printed on the capsule anywhere. For items that are subject to high wear, information can be quickly worn off the surfaces by friction, the codes can be made to be very small so that they can be placed in protected areas. For example, for bullets the code can be placed on the flat base of the bullet, inside the protective casing. The act of firing does not harm the code etching and the base of the bullet is likely to be the part least deformed by subsequent impact with the target. Thus, in addition to the standard process of determining which gun fired a bullet, a crime scene investigator can quickly establish who sold the bullet, and perhaps who bought the bullet.

For some objects, it is not practical or viable to place the code directly on the object. For example, it is not practical to mark a liquid itself. But a manufacturer can mark its product containers with the codes. Or an insert imprinted with the code can be placed in the package with the container. Skilled artisans will recognize other ways in which the code can be coupled to the object.

Another situation in which it is inconvenient to place the code on the object being marked is for granular items such as agricultural products, where marking each granule is not practical. Instead, coded, separable markers which provide the necessary tracking information without affecting downstream processing, can be added to the product.

Sometimes the location for the code is chosen for other reasons. For example, an object might be designed to be used only once, after which it should be discarded. The code can be placed somewhere on the object so that the code is destroyed when the object is used. The fact that the code is no longer present on the object lets others know that the object has been used.

Laser surface authentication. In one embodiment, the scanning process comprises laser surface authentication. A recently described method and apparatus provides authentication of an item based upon a characteristic unique physical identity code produced by directing a laser on an object and observing the scatter pattern produced by the microscopic imperfections in the surface of the item. The inventive subject matter thus provides for associating unique physical identity codes with items, preferably at the time of manufacture or assembly, either as to individual commercial items or to packaging thereof.

The system associates the unique physical identity code with an item and records the code and item identifier in a database or registry. The code is then available to be transmitted to a downstream user, such as a supplier, distributor, or retailer, who can then make inquiries of the system to learn about the item, can test the item for a match to the unique physical identity code, and/or can provide additional information about the item for the database.

In one embodiment, materials incorporated into or associated with an inventory item are tested. Paper documents, plastic cards, and product packaging contain a unique physical identity code formed from microscopic imperfections in the surface of the item or packaging. This unique physical identity code is intrinsic to the material and virtually impossible to controllably modify. It can be rapidly read using a low-cost portable laser scanner.

Assigned randomness in the unique identifiers assigned to an attached tag, such as an RFID tag, bar code, or alphanumeric code matrix is one means of ascribing a unique identifier to items and their packaging. On the other hand, naturally occurring randomness in the physical properties of a unique physical identity code is an alternate means of ascribing a unique identifier. It has been determined that using the intrinsic roughness present on a non-reflective surface is a source of physical randomness which can be exploited to create unique physical identity codes.

It has been found that the diffuse scattering of a focused laser produces a measurable optical phenomenon defined by the fine structure of a surface, as described in Example 2. This technique is well known and has been used for determining, among other things, surface roughness, small deformations of metal and wet paper, shear moduli of papers, and for visualizing blood flow in vivo.

Statistical analysis indicates that there are pseudorandom fluctuations that have a minimum wavelength of 70 μm. The fluctuations from the mean intensity are digitized into ones and zeros to form the fingerprint code for the object.

Recognition is good even after the object is roughly handled. For paper, this includes crumpling and smoothing to leave a badly creased surface; soaking in water, followed by natural drying; baking in air at 180° C. for 30 min to scorch the surface; scribbling heavily over the scanned area with a ball-point pen and/or a thick black marker pen; or scrubbing the surface with an abrasive cleaning pad. Misplacements of the object on the scanner by up to ±1 mm and 2° were judged acceptable.

The amplitude of the cross-correlation peak can be used to determine the probability of two objects sharing indistinguishable fingerprints. For the paper studied in Example 2, the probability was less than 10⁻⁷². Smoother surfaces, such as matt-finish plastic cards and coated paperboard, typically give probabilities of less than 10⁻²⁰. The speckle signal therefore serves as a virtually unique data set for each object. Each data set requires about 200-500 bytes of storage space, making storage of a very large number of data sets feasible, and requiring nothing more than a standard personal computer, or a set of networked computers such as might be linked between a group of manufacturers, suppliers, distributors, and customers in an inventory control system.

Laser surface authentication provides authentication and tracking which it is believed cannot be copied or counterfeited, as there is no known manufacturing process for copying surface imperfections at the required level of precision. Using such an authentication system, there is no need to modify an item in any way. Tags, chips, special inks, and so forth would be rendered obsolete.

The benefits which can derived from the use of RFID-enabled tracking and authentication systems such as the inventive subject matter include the following:

Inventory Visibility. Widespread implementation of RFID throughout a supply chain will provide the ability to determine where items are located. This would expect to result in greater opportunity for collaborative forecasting, planning and replenishment between multiple parties such as manufacturers, suppliers, distributors, and customers. For example, improved visibility enables manufacturers to more accurately produce items that the demand chain will need to meet retailer and consumer needs. Specific areas that are expected to be improved include: shrinkage reduction, visibility of incoming raw materials, excess inventory reduction, control of work in progress, and better sequencing of raw materials/subcomponents.

Recall Management. Recalls can create havoc throughout a supply chain because of the difficulties associated with identifying where all items to be recalled are located. It is expected that RFID will be able to identify where items are located in the supply chain, and more specifically which particular items involve the recalled foods, materials, or components. It is expected that more selective recalls will dramatically reduce unnecessary handling costs related to, and losses thorough destruction of, good items which are returned along with recalled items.

For example, tracking of tires in the event of a recall may be one of the first wide-spread uses of RFID for auto item life cycle tracking. The National Highway Traffic Safety Administration's TREAD (Transportation, Recall Enhancement, Accountability and Documentation) Act mandates that the automotive industry develop a way to track tire recalls.

Product Authentication. It is expected that RFID is part of the solution to counterfeiting problems in a variety of industries. It is expected that RFID, applied properly to imported aftermarket parts for example, will significantly curtail this problem and limit manufacturer liability for defects in counterfeit items.

Labor Savings. Strategic placement of tracking systems such as RFID readers can detect the flow of items in and out of an area. This enables the system to understand where products are located and can provide data on how many products are in a certain area. The higher the level of use of RFID in a facility, the less labor is required to manually count, manually scan, or locate individual items and containers. This will result in bottom-line cost savings.

Tracking Reusable Assets. Containers, racks, and other items used in the production and movement of products are assets carried on company balance sheets, and require management and tracking. These assets represent costs due to shrinkage, wear, damage, and inability to locate them. It is expected that RFID technology will enable manufacturers and their trading partners to track container location, contents, and condition, resulting in improved management of asset costs.

Tracking Maintenance, Repair, and Overhaul (MRO) Assets. Typical manufacturers of mechanical devices have sizable investments in replacement parts, tools, and related equipment. Managing optimal levels of these items is essential to minimizing costs and ensuring manufacturing processes experience as little downtime as possible. RFID tags placed on tools, parts, parts containers, and/or equipment can provide data to help eliminate loss due to theft, misplaced items, and poor visibility of items.

Product Location. The inventive systems and methods provide Real Time Locating Systems (RTLS) utilizing RFID tags, software, and triangulation systems to locate items, containers, and pallets. RTLS systems transmit information, such as item identification and location, at varying intervals with a low-power radio signal. A central processor receives the signals from different tagged items and continuously provides information on the locations.

### THE INVENTIVE SYSTEMS

The inventive subject matter further relates to a system for tracking, authenticating, or tracking and authenticating an object through a chain of custody, comprising the following elements, operably connected:

(a) a computer having a storage medium;

(b) a database residing on said storage medium, in which at least the following data is stored:

information relating to said object,

information associating said object to an identifier code which is unique to said object, and

information relating to user permissions or roles permitting a user to have access to some or all of the information in said database;

(c) client software residing on said storage medium which provides an interface to said database, wherein:

(i) said client software identifies users and allows users to be classified into groups, and wherein permissions or roles are assigned to such groups,

(ii) said client software tracks said object in said system by detecting said unique identifier code at each time event in which said object is transferred from one party in the chain of custody to another, or from one location in the chain of custody to another, and collects and stores the identity of each party who takes custody of said object at each time event, and

(iii) said client software provides access to information establishing the chain of custody of said object.

In one aspect of the inventive subject matter, said client software further collects and stores the identity of each said party who relinquishes custody of said object at each time event.

In another aspect of the inventive subject matter, said client software further collects and stores the location of each transfer of custody of said object at each time event.

In a further aspect of the inventive subject matter said client software further collects and stores in said database information relating to the quantity of objects of a particular type; and aggregates said tracking data for a plurality of objects of a particular type.

In an alternate aspect of the inventive subject matter, said unique identifier is selected from the group consisting of said object identifier, a unique first-level package identifier marking a plurality of objects packaged into a first-level package, a unique second-level package identifier marking a plurality of first-level packages, and higher-level unique package identifier marking a plurality of lower-level packages, wherein a new package level encompasses a plurality of packages from the preceding package level.

In yet another aspect of the inventive subject matter, said unique identifier code is assigned by the original source of said object.

In another aspect of the inventive subject matter, said unique identifier code is assigned an associated expiration date.

In a further aspect of the inventive subject matter, access to information establishing the chain of custody of said object is provided by said client software generating a chain of custody report.

In an alternate aspect of the inventive subject matter, access to information establishing the chain of custody of said object is provided by said client software generating one or more alert notifications.

In a preferred embodiment, said one or more alert notifications is selected from the group consisting of an unauthorized party or user alert notification, an unauthorized location alert notification, an excess quantity alert notification, an insufficient quantity alert notification, a past expiration date alert notification, and combinations thereof.

### EXAMPLES

The following examples are illustrative of the inventive subject matter and are not intended to be limitations thereon.

### Example 1

### Enhanced Tracking And/or Verification of the Authenticity of Pharmaceutical Items

According to one aspect of the inventive subject matter, each of a plurality of individual pills is marked with a unique alphanumeric matrix identifier by the manufacturer. An identified group of pills so marked is placed in a container, such as a bottle, which is in turn marked or tagged with its own unique identifier, for example a passive RFID tag. Data indicating the association between the plurality of unique alphanumeric matrix identifiers associated with each pill and the unique identifier for the bottle is recorded and stored in one or more database(s).

An identified group of bottles so marked is placed in a container, such as a box, which is in turn marked or tagged with its own unique identifier, for example a separate passive RFID tag. Data indicating the association between the plurality of unique RFID identifiers associated with each bottle and the unique identifier for the box is recorded and stored in the same or different one or more database(s).

An identified group of boxes so marked is placed in or on a container, such as a pallet, which is in turn marked or tagged with its own unique identifier, for example an active RFID tag. Data indicating the association between the plurality of unique RFID identifiers associated with each box and the unique identifier for the pallet is recorded and stored in the same or different one or more database(s).

For example, upon occurrence of the need to track or trace the source, distribution path, or authenticity of a particular pill, for example to determine that the pill has a clean e-pedigree and can be provided to a consumer, the database(s) can be checked for the unique identifier associations so recorded, and cross-checked against the unique identifier associations actually found at one or more stages of the distribution channel. Confirmation of all expected associations may be interpreted as clearance to provide the product to a consumer. Failure of one or more expected association(s) may be interpreted as an indication of possible tampering or counterfeiting, and may trigger an indication that the product should be removed from commerce for further evaluation of source, distribution path, or authenticity.

Thus, in an anti-drug counterfeiting example, the inventive subject matter provides a state of tracking and authentication which reliably and affordably provides much greater assurance that after manufacture, a drug product is distributed under conditions that do not compromise its integrity and potency. This approach is a much more reliable direction for assuring the legitimacy of a drug than paper record keeping, which is more likely to be incomplete and subject to falsification. Thus, the inventive subject matter will help secure the integrity of the drug supply chain by providing an accurate drug “e-pedigree,” which is a secure record documenting that the drug was handled under safe and secure conditions from leaving the manufacturer to use by the consumer.

### Example 2

### Laser Surface Authentication, Tracking, and/or Verification

In an exemplary technique for determining and recording a unique physical identity code formed from microscopic imperfections in the surface of an item, scanning a focused laser beam across the surface of the item and continuously recording the reflected light intensity from four different angles by using four photodetectors. The scanner uses a 635 nm collimated laser diode which is focused to a line on the surface of the document using a cylindrical lens of focal length 16 mm. The focused line is approximately 70 μm wide and 4 mm long, and has an average angle of incidence of zero, i.e. the optical axis is along the surface normal.

The laser and focusing optics are mounted on a linear motion drive which scans across a surface at a speed of 20 mm per second, in a direction parallel to the short axis of the focused laser line. Four phototransistors monitor the focused line and measure the intensity of reflected light at angles of reflection of −50°, −20°, +30° and +60°. Preferably, the −20° and +30° photodetectors are centered on the middle of the line, while the −50° and +60° photodetectors are offset transversely to the direction of motion, from the middle of the line by ±1.5 mm respectively. The signals from the photodetectors may be AC coupled and then amplified before being digitized at a rate of approximately 500 samples per second. A signal from an optical position encoder is also digitized in order to compensate for fluctuations in the motor speed, and may be correlated with the data recorded by the photodetectors.

In order to obtain a quantitative measure of the degree of uniqueness of the physical document identifier, 500 sheets of paper from the same pack were taken and each scanned once. Three days after the first set of scans was performed, a second set of scans from the same 500 sheets of paper was taken. Each scan in the first set was compared with the scan in the second set from the same item. This test shows that the discrimination is excellent. The fraction of blocks matching when different sheets are compared was clearly different from when the same sheet is scanned twice. Each sheet of paper was thus readily identified from all of the others. A third set of scans, performed 3 months later and then compared against the first set, also reported perfect discrimination of the 500 documents.

In a digital cross-correlation between one scan and a similar scan from a different sheet of paper from the pack, the absence of any strong peak indicates that the scans are independent of each other. By contrast, the digital cross-correlation between the original scan and a subsequent scan from the same sheet of paper taken three days later, with normal handling of the paper in between, shows a strong peak close to zero positional shift, which indicates that the scans are largely identical. Similar results were obtained from matt-finish plastic cards (such as credit cards), identity cards, and coated paperboard packaging such as is used to pack pharmaceuticals and cosmetics, for example.

The data also shows that all 500 of the second set scans matched their corresponding first set scan with a uniqueness factor of at least 10⁵¹. A single outlier point was found to be due to the item being badly positioned during the second scan; when correctly positioned, the point joined the main body of data. Without this mis-scan, all of the second set scans matched their corresponding first set scan with a uniqueness factor of at least 10⁷².

The amplitude of the cross-correlation peak was used to determine the probability of two objects sharing indistinguishable fingerprints. For the paper studied in this Example, the probability was less than 10⁻⁷². Smoother surfaces, such as matt-finish plastic cards and coated paperboard, typically give probabilities of less than 10⁻²⁰.

### Example 3

### Chain of Custody of Items of Physical Evidence

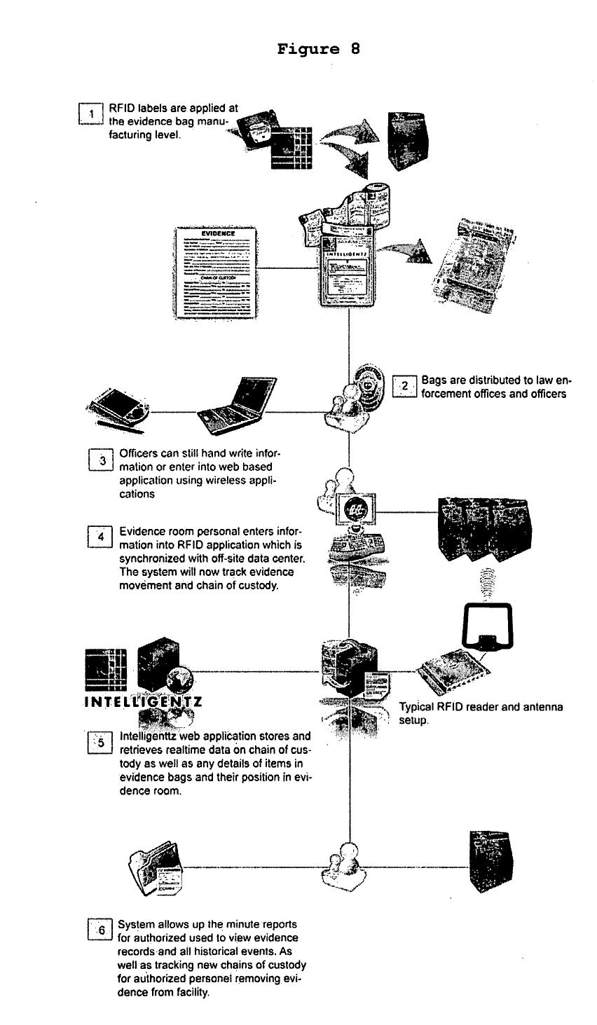

According to one aspect of the inventive subject matter, as shown in FIG. 8, physical evidence may be tracked as follows:

1. A unique identifier tag or label, which is preferably RFID, is applied at the evidence bag manufacturing level.

2. Bags are distributed to law enforcement agencies.

3. At evidence intake, Officers optionally hand write information, which is consistent with most current practices, or enter data into a web based application using a wired, or preferably wireless, interface.

4. Authorized evidence room personnel enter information regarding evidence into RFID-enabled application, which is preferably synchronized with an off-site data center, along with assigning security permissions and roles for user access to evidence. The system thereafter tracks evidence movement and chain of custody, and restricts permitted access to the item.

5. Web application stores and retrieves real-time data on chain of custody, details of items in evidence bags, and item location in evidence room or court facilities.

6. System allows up to the minute reports for authorized users to view evidence records and all historical events, as well as tracking new events relating to authorized personnel removing evidence from facility.

### Example 4

### Event Ticket Authentication

According to one aspect of the inventive subject matter, an exemplary method for authenticating event tickets is as follows:

1. Upon first issuance of an event ticket, the original recipient is requested to provide a unique identifier to be associated with the ticket. By way of example and without limitation, such an identifier may be the original recipient's mobile telephone number. Such information is recorded and saved to a database, along with any restrictions on use of the ticket.

2. The original recipient and subsequent holders would have access to the database, and would be able to record a permitted transfer of the ticket to a third party, creating a new association with a unique identifier for each transfer. Holders would also be able to report the ticket as lost or stolen, warning potential subsequent transferees not to purchase such invalid tickets.

4. If the ticket is validly presented according to the terms of issuance, no further action is required and the ticket information may be purged from the system upon presentation. If the original recipient desires to transfer the ticket to a third party (for example, an individual or ticket broker) and can validly do so, the third party would have access to the database to determine if there are restrictions on use of the ticket and/or whether the most recent holder has reported the ticket lost or stolen.

### Example 5

### Exemplary Inventory Management Systems and Methods

It will be readily apparent to one of ordinary skill in the art that the inventive subject matter may require access to the inventory databases of multiple manufacturers, suppliers, distributors, retailers, other sellers, or a combination thereof. With appropriate permissions and roles, multiple individual company databases, shared databases, or both can be searched. In one aspect of the inventive subject matter, such multiple or shared databases are as described in Applicant's U.S. patent application Ser. No. 09/799,879, filed Mar. 7, 2001, now U.S. Pat. No. 6,998,538, issued Feb. 7, 2006, the entire contents of which is hereby incorporated by reference in its entirety, and selected sections of which are included below.

The following example illustrates a preferred inventory management system which is optionally used to create and maintain the at least one database having information relating to an inventory item, as described in detail herein.

### Background Of Preferred Inventory Management

Traditionally, inventory control has been done by the company or organization using the items in the inventory. In smaller offices, inventory control is typically not a high priority, and orders may be placed whenever items are out of stock.

As an office increases in size, inventory management becomes more of a challenge, and monitoring of frequently used or crucial items becomes very important. Typically a person is given the responsibility of monitoring inventory and ordering replacements as supply diminishes. As a company further increases in size, more advanced inventory management techniques may be used. For example, supply and usage trends may be analyzed to determine minimum quantities on hand, and seasonal or other peak usage may be determined.

Some larger offices have switched to automated or semi-automated inventory tracking systems. These automated systems utilize barcode scanners or other electronic identifiers to track outgoing and incoming inventory, and can prepare purchase requests as supplies diminish.

### Summary Of Preferred Inventory Management

The preferred inventory management system improves upon the prior art by shifting the burden of inventory tracking onto a third party; this concept is referred to as vendor managed inventory, or VMI. When a third party provides VMI services for multiple companies, it gains significant buying power which it can use to negotiate better deals, improve supplier responsiveness, and streamline the buying process.

The preferred inventory management system allows third-parties to monitor company inventory via the Internet and World Wide Web (“web”). In addition, the preferred inventory management system allows small to medium sized companies to take advantage of VMI by providing a cost-effective solution to their inventory tracking needs.

The preferred inventory management system utilizes web-enabled technologies to revolutionize inventory management by tracking inventory and automatically contacting suppliers, manufacturers, or distributors when additional supplies are needed. This may result in a labor reduction as compared to the labor-intensive inventory maintenance systems currently deployed.

In addition to reducing labor costs, the preferred inventory management system may help a company cut other costs. The preferred inventory management system may help reduce delivery costs by regularly ordering supplies in anticipation of need, thus obviating the need for express shipments. The preferred inventory management system may also allow third parties to take advantage of manufacturer or distributor specials when offered for the products its customers require, thus further reducing customer cost.

While purchasing is a large part of inventory maintenance, the preferred inventory management system may also facilitate other transactions as well. For example, the preferred inventory management system may allow customers to resell products or equipment to other businesses, thereby maximizing utility. Although some in the prior art, such as Neoforma.com and Medibuy.com, have attempted to provide business-to-business equipment resale through web-based auctions, auctions do not provide equipment availability assurances. The preferred inventory management system provides a forum through which resellers and customers may interact, where the preferred inventory management system acts as a broker, thereby assuring both that purchased equipment is delivered, and that a seller receives proper compensation.

### Detailed Description Of The Preferred Inventory Management

The preferred inventory management system implements an Internet-based, vendor managed inventory (“VMI”) system. A VMI system allows a customer to reduce costs by pushing inventory management responsibilities onto a third party, or manager. Managers may service multiple companies, thus allowing them to negotiate better deals, improve supplier responsiveness, and serve as an effective customer advocate.

The preferred inventory management system allows managers to inexpensively monitor customer inventory via the Internet and World Wide Web (“web”). The preferred inventory management system utilizes web-enabled technologies to revolutionize inventory management by tracking inventory and automatically contacting suppliers, manufacturers, or distributors when products are needed. This may result in a labor reduction as compared to the labor-intensive inventory maintenance systems currently deployed.

FIG. 1 is a block diagram illustrating the major hardware components of the preferred inventory management system. As illustrated in FIG. 1, the preferred inventory management system utilizes a client/server architecture to facilitate communication between customer inventory systems and managers. A client running on a Customer Inventory System 130 may be used to track inventory, place special orders, and interact with other customers.

A client may include custom software, such as an application written in Visual Basic, JAVA, or C; commercial software, such as a web page accessible through a web browser; or a combination of custom and commercial software, such as a “plug-in” which operates in a web browser. Examples of common web browsers include Internet Explorer, developed by Microsoft Corporation of Redmond, Wash., and Navigator, developed by Netscape Corporation of Mountain View, Calif.

Customer Inventory Systems 130 may allow manual inventory tracking, semi-automated inventory tracking, or inventory may be dispensed using automated systems. By way of example, without intending to limit the preferred inventory management system, a preferred embodiment of the preferred inventory management system includes a handheld device, such as a Palm VII device by Palm Computing, Inc., to be outfitted with a barcode scanner. Such a device can allow barcodes or other identifiers associated with each inventory item to be scanned or otherwise entered into the system prior to or at the time of item distribution. As each item is scanned, a count maintained by the preferred inventory management system may be adjusted to properly track inventory levels. Recipient-specific labels, including product warnings and other information, can then be printed for each scanned item.

Other inventory distribution methods contemplated include, but are not limited to, interfacing the preferred inventory management system with vending machines. Vending machines may allow accurate inventory tracking without requiring human interaction, except to periodically restock a particular supply or group of supplies. In a preferred embodiment, vending machines may include security measures to prevent unauthorized supply distribution.

Such security measures may include, but are not limited to, the use of an identification card and personal identification number (“PIN”), and biometric systems. Vending machines equipped with security systems may restrict access to specific supplies on an individual-by-individual level, or group-by-group basis. Vending machines may also be equipped with label printers that allow warnings and other information to be attached to a dispensed item's packaging.

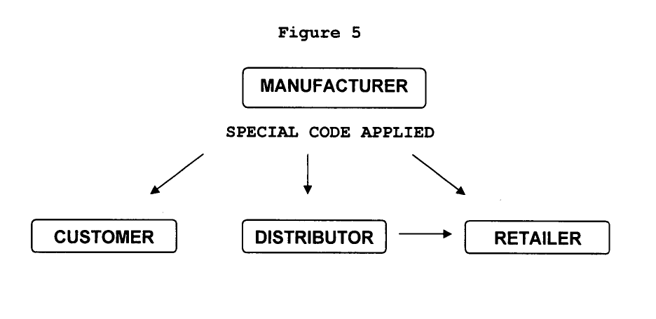

Alternatively, supply closets or other storage areas can be outfitted with a Radio Frequency Identification (RFID) portal, as illustrated in FIG. 5. An RFID portal (Block 500) is similar in structure to airport security metal detectors, except that RFID portals can detect or scan RFID tags as such tags pass through a portal. The preferred inventory management system can monitor RFID tag identifiers, including identifiers assigned to individuals, such that access to a storage area can be monitored, and items removed by an individual can be tracked without any direct user interaction.

A preferred embodiment of the preferred inventory management system can also track individual product dispensation, and may require additional information as products are dispensed. By way of example, without intending to limit the preferred inventory management system, if a doctor dispenses sample medication to a patient, the preferred inventory management system may also request a patient identifier, whereas if a package of gauze bandages was removed from inventory to restock an examination room, the preferred inventory management system may not request a patient identifier. Patient identifiers can be used by the preferred inventory management system to generate dispensation history reports for various products which may help suppliers and manufacturers to better understand income, race, ethnicity, or other demographic characteristics of typical recipients. The preferred inventory management system may restrict such reports to only demographic information, and may not include individual-specific information in such reports.

An alternative embodiment of the preferred inventory management system allows physicians or others to carry a handheld device through which prescriptions can be written while talking with a patient. Such a handheld device can connect to a local inventory management system through a wireless or wired means, and, when appropriate, a prescribed item sample may be automatically dispensed by a vending machine. Alternatively, a message may be displayed at a nurse's station indicating the items to be pulled from inventory. When items are dispensed by a vending machine or pulled from inventory, inventory counts can be decremented as appropriate, and new orders can be placed as necessary.

As inventory is distributed, Customer Inventory System 130 may track supply usage habits to determine minimum acceptable quantities on-hand. Usage information may be studied for various periods of time, and the preferred inventory management system may create an inventory usage model based on collected data. As models are created and refined, the preferred inventory management system may modify minimum in-stock thresholds to reflect anticipated usage. As quantity in-stock approaches a calculated or specified threshold, Customer Inventory System 130 may automatically request new supplies from Server 100. Supply requests may include various information, including, but not limited to, urgency of request, customer willingness to accept alternative brands or sizes, billing information, and shipping information.

As Server 100 receives supply requests, Server 100 may request price quotes from several Manufacturer, Supplier, or Distributor 120's (“Distributor 120”). Distributor 120 may respond with quantity available, price, estimated delivery time, and other such information. Server 100 may then automatically evaluate each Distributor 120 response to find the best value given various factors associated with each customer request. When an appropriate Distributor 120 response is chosen, Server 100 may automatically arrange payment and shipping of requested supplies for Customer Inventory System 130.

Communication between Customer Inventory System 130, Server 100, and Distributor 120 may be achieved through various methods, including, but not limited to, hypertext transfer protocol (“HTTP”), file transfer protocol (“FTP”), simple mail transfer protocol (“SMTP”), or other such related methods.

Although purchasing is a large part of inventory maintenance, a preferred embodiment of the preferred inventory management system may also facilitate communication between customers, provide a source of information dissemination, and encourage customer interaction. The preferred inventory management system may facilitate customer communication by allowing customers to resell products, equipment, or excess inventory to other businesses. The preferred inventory management system may allow information dissemination by providing an up to date catalog of available equipment and other inventory from which a customer may order. The preferred inventory management system may facilitate customer communication by allowing managers and customers to author and distribute articles describing new rules, regulations, procedures, revenue generation prospects, or other information of interest to other customers.

Customer Inventory System 130 may serve as the primary source of customer interaction with the preferred inventory management system. Articles, catalogs, inventory information, and other such information may be stored on Server 100, and Customer Inventory System 130 may communicate with Server 100 to obtain requested information.

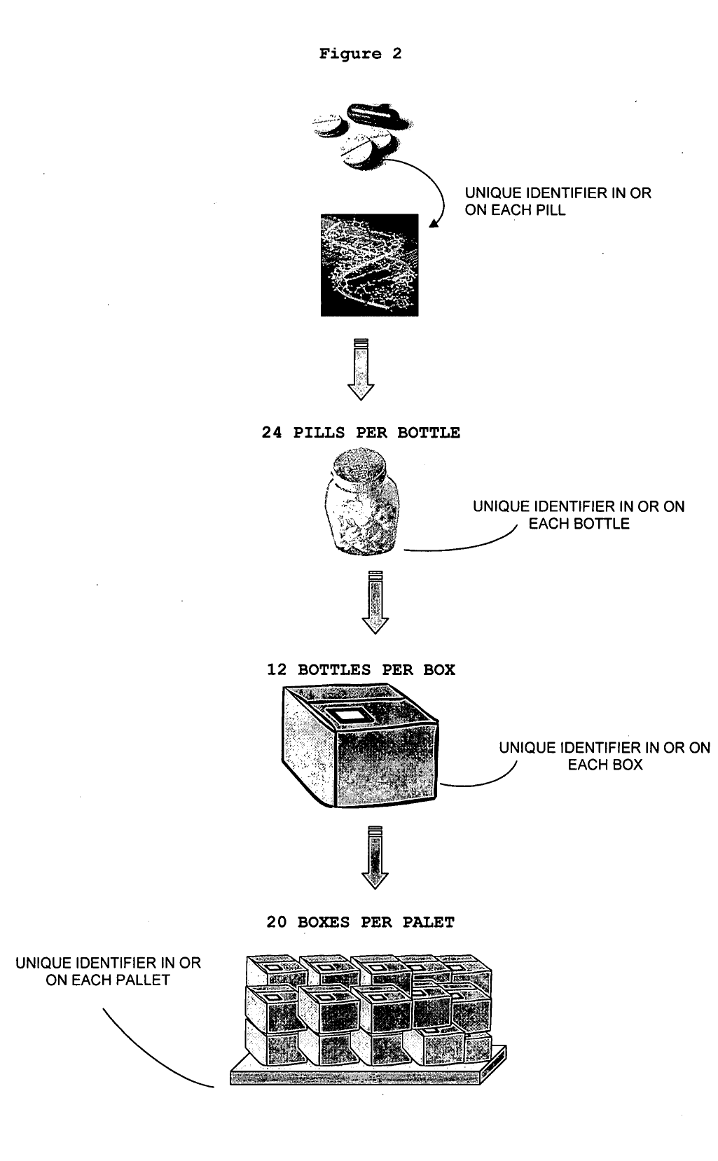

FIG. 2 illustrates a preferred embodiment of Server 100, in which relationships between data storage, web server, and application services provided by Server 100 are illustrated. All client communications may first pass through Firewall 210. Firewall 210 represents a combination of software and hardware which is used to protect the data stored in Web Server 220, Database Server 230, and Application Server 240 from unauthorized access.

As previously described, clients may communicate with the preferred inventory management system through various protocols, including HTTP. Web Server 220 represents software capable of transmitting and receiving information via HTTP or other protocols. Examples of such software include Internet Information Server, developed by Microsoft Corporation of Redmond, Wash.; Enterprise Server, developed by Netscape Corporation of Mountain View, Calif.; and Apache Server, developed by the Apache Software Foundation of Forest Hill, Md.

When a client requests information, Web Server 220 may determine whether a client request requires pre-processing, in which case a request is transferred to Application Server 240, or if a request simply requires data to fulfill the request, in which case Web Server 220 may communicate directly with Database Server 230.

Database Server 230 represents commercially available database software, such as Microsoft SQL Server, developed by Microsoft Corporation of Redmond, Wash., Oracle 8i, developed by Oracle Corporation, of Redwood Shores, Calif., or other, similar software. Database Server 230 may store raw data, such as customer inventory information, customer addresses, vendor names, vendor product classes, and other such similar information. Such information may be transmitted to a client by Web Server 220, or Application Server 240 may interpret information stored in Database Server 230 prior to transmission.

Application Server 240 may contain business rules associated with the present invention, which can be used to interpret Database Server 230 data prior to transmission of that data to a client. In addition to interpreting information stored in Database Server 230 for client use, Application Server 240 may also monitor inventory levels reflected in Database Server 230, contact vendors based on information from Database Server 230, adjust inventory information as new inventory is received, and provide the services necessary to facilitate business-to-business resale of equipment or products stored in Database Server 230.

Web Server 220, Database Server 230, and Application Server 240 each represent software which may run on the same computer, or on multiple computers. In addition, Application Server 240 may be implemented within Database Server 230 as a set of business rules.

An alternative description of the preferred inventory management system follows, in which the preferred inventory management system is described through a series of functional specifications. This information is included for enablement purposes, and describes the best mode contemplated at the time the present specification was filed. While the following functional specification describes a preferred embodiment of the preferred inventory management system, descriptions within the functional specification should not be construed as limiting the preferred inventory management system.

To avoid confusion, the following terms are used in this functional specification:

Customer—Refers to a buyer of products via the preferred inventory management system. Customers can have “open account” relationships to avoid credit card and COD shipment problems.

Linked Supplier—A distinction is made to avoid confusion with other vendors doing business with the preferred inventory management system, given that payables may be in a common accounts payable system. Distributors, manufacturers, or other vendors (collectively “suppliers”), are distinguished by whether they are using the preferred inventory management system's inventory tracking and accounting software, and therefore have live Internet linkages into their databases for queries, order processing, and billing.

Manual Supplier—If a supplier provides goods or services through the preferred inventory management system, but tracks inventory through a manual interface, such a supplier may be termed a “Manual Supplier”. Open account relationships may be maintained between Linked or Manual Suppliers avoid payment complexities.

Non-linked Supplier—Suppliers not linked to the preferred inventory management system.

Products—Items for sale via the preferred inventory management system.

Customer Inventory—A list of products to be maintained at a given customer site.

In addition to the general definitions set forth above, this functions specification also defines a set of system functions. System functions may fall into one of the following general sub-system categories:

Interactive—human interface and related functions for tracking inventory counts, inventory consumption rates, ordering critical products, and the like. Interactive processes may be web-based or PC-based (client-server).

Nightly Processes—periodic processes through which orders can be generated and invoicing and related processes can be performed, including interaction with Distribution system at distributor warehouses.

Corporate—processes performed within corporate offices, but which update a database. Includes accounting, client data management, and other such processes.

Distribution—Linked Suppliers integrated with the preferred inventory management system. Industry standard Enterprise Resource Planning (ERP) software may be bundled with commercial financial software to provide a complete business system to Linked Suppliers.

Database Design—A database schema which may he utilized in a preferred embodiment of the preferred inventory management system.

The preferred inventory management system in general, and this functional specification specifically, defines styles and functions included in detailed web pages and other user interface elements that are intended to be available system wide. Web pages, application windows, program screens, and transactions within the preferred inventory management system should observe common rules. These rules include, but are not limited to:
No customer can view, inquiry into, update or in any way alter another customers data. Transactions can use an IP address or other unique identifier as a cross-check against a customer ID coming in with transmitted pages to insure rule enforcement. For such security procedures, customer IP addresses or other unique identifiers may only be changed through a function accessible only to Corporate staff.
No Linked Supplier can see data belonging to another linked supplier.
System parameters controlling customer options can be set through an account setup and editing process. Such a process may be accessed by only someone with an authorized identifier. Initially, such identifiers may only be given to Corporate Staff.
Data changes will generally be reflected by a transaction log or transaction history, which may be accessible to customers or distributors, and to which Corporate Staff with appropriate security levels may have access.

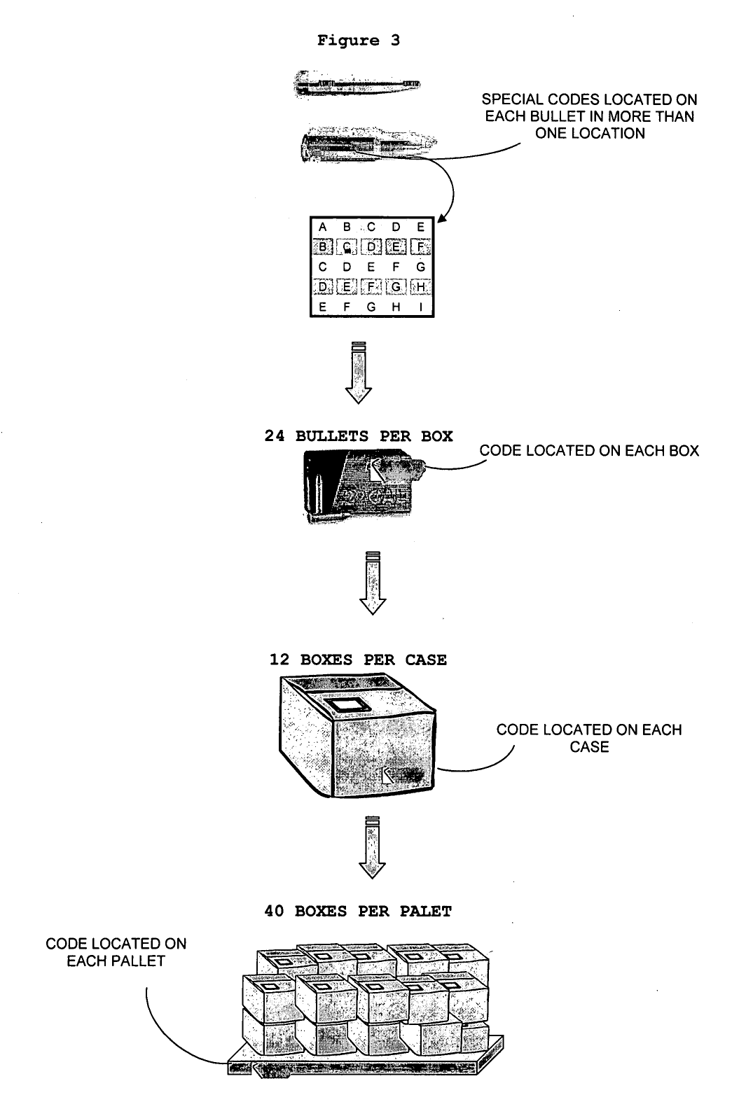

Functions involving data changes may be performed as server-side scripts, rather than through client-side logic. In general, such server-side scripts can utilize a logical flow similar to FIG. 3. As FIG. 3 illustrates, client software running on a customer machine may generate a page containing data to be updated by a web server and transmit said page to said web server (Block 300).

When a web server receives a page from a customer machine, the preferred inventory management system may attempt to process any changes requested by said page. If such changes are successful (Block 320), the preferred inventory management system may return a confirmation page or cause a confirmation message to be displayed to a customer machine, and appropriate transaction logging may occur.

If changes are not successful, the preferred inventory management system may increment a retry count by one (Block 340). If the retry count is less than or equal to three, the preferred inventory management system may retransmit customer changes (Block 370) to Block 310 in an effort to make any appropriate changes. If the retry count exceeds three (Block 350), the preferred inventory management system may cause a page containing any error codes or other feedback information to be displayed on a client machine. Such a page may also contain original client data changes as well as a means for resubmitting said changes (Block 360).

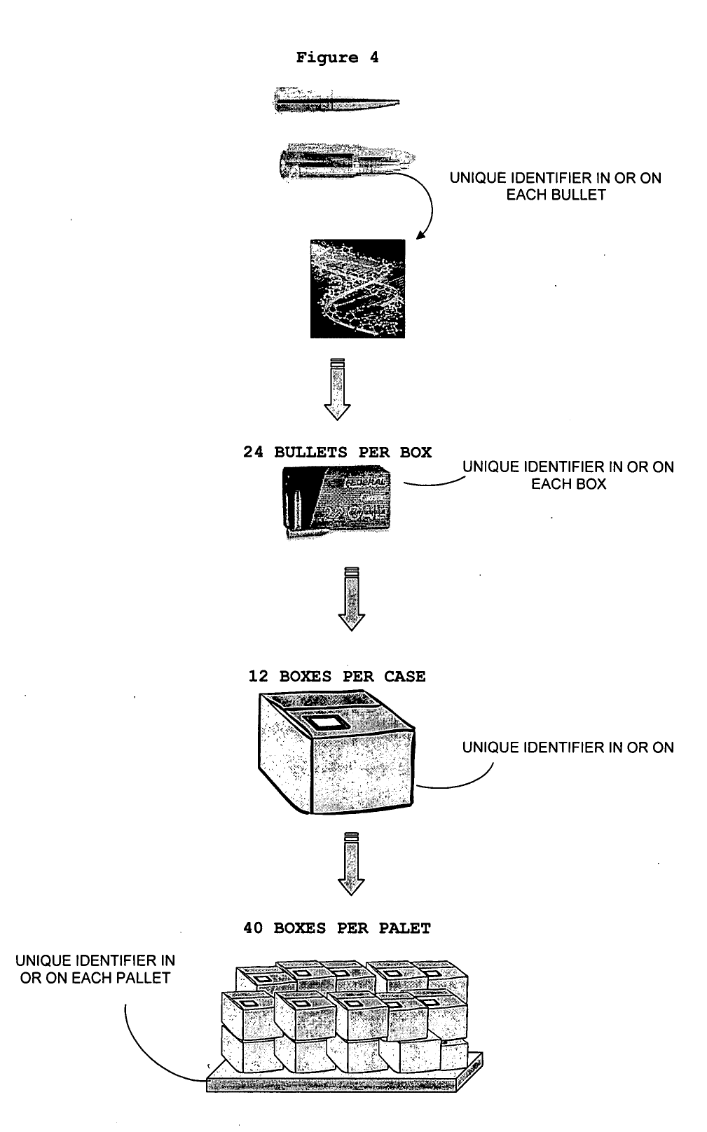

Client software may also periodically verify that a data connection exists between said client software and a server acting as part of the preferred inventory management system. Such software may follow the logic illustrated in FIG. 4 to achieve accurate data connection monitoring. As Block 400 illustrates, client software may send one or more TCP/IP Ping commands or other network test commands to verify that a high-speed connection is still available to a server acting as part of the preferred inventory management system.

If a high-speed network connection is detected, the preferred inventory management system can continue normal operations (Block 410). If a high-speed network connection is not detected, the preferred inventory management system may attempt to reestablish such a connection (Block 420). If a high speed network connection can be reestablished (Block 430), the preferred inventory management system may continue normal operations (Block 410). If a high-speed network connection cannot be established, a lower speed network connection, such as a dial-up network connection, may be established by the preferred inventory management system (Block 440). If a lower speed network connection can be established, the preferred inventory management system may continue normal operations, including periodically attempting to reestablish a high-speed network connection (Block 410).

If a lower speed network connection cannot be established, client software may display an application or page with alternative user interface and alternative functionality (Block 460). Such alternative functionality can include local storage of product usage information, local inventory tracking, and limited reordering via a dial-up or other temporary connection with a known supplier (Block 470). A client functioning without a data connection may periodically attempt to reestablish high or low speed network connections (Block 480). When a connection is reestablished (Block 490), a client may transmit product usage scan information to a server acting as part of the preferred inventory management system.

In addition to an inventory tracking application, the preferred inventory management system may also utilize a high speed network connection to transmit new product offerings or special promotions to a client for display to a customer. As new products are entered into a Products table or similar data structure, the preferred inventory management system may cause such a product to appear on a client. In a preferred embodiment, the preferred inventory management system may allow customers to select products in which a customer is interested, and the preferred inventory management system may only display new products or special deals meeting a customer's prior specifications. Such specifications can include, but are not limited to, categories by manufacturer, product trade name, specific product type, general product classification, and quantity available or quantity per shipping unit.

A client displaying such information may allow a customer to indicate an interest in a product by typing a command, clicking a button or other graphical interface element, or otherwise interacting with said client. If a customer expresses an interest in a featured product, a client may allow a customer to create a one-time order, or to configure recurring orders.

In addition to allowing customers to record product usage and order new inventory or new products, client software may also display advertisements on a rotating basis, and may be used for other purposes. A typical client software screen may also contain additional information and fields, including, but not limited to, a Product SKU field, a User-ID field, a Doctor-ID field, and a Sales Consultant Contact field.

When customers are not directly interacting with client software, client software may place a cursor in a Product SKU field by default. Placing a cursor in a Product SKU field can allow client software to ready accept an automatically or manually entered product identifier, such as a barcode label scanned via a wedge-style bar-code scanner.

As product identifiers are entered, client software may request a User-ID for each product identifier or set of product identifiers. A User-ID is a unique identifier created for each employee or set of employees within an organization. Such identifiers may be entered manually through an active user interface, such as, but not limited to, a keyboard, touch screen, or number pad, or through a passive user interface, such as, but not limited to, biometric recognition equipment, barcode identifiers worn by or associated with an employee, or through RFID tags worn by or associated with an employee. User-ID's may be combined with passwords to create a more secure inventory tracking system.

User-ID's may be used to track persons removing items from an inventory, but additional tracking or other controls may also be desirable. For example additional authorization may be required when employees remove expensive items or controlled substances from an inventory. The preferred inventory management system may recognize when such an inventory item is removed, and client software may request an additional identifier, called a Doctor-ID, as authorization. Client software may even allow any user to enter a Doctor-ID for some inventory items, while for other inventory items a Doctor-ID and related password may be required. A biometric or other positive identifier may be used in place of a Doctor-ID or Doctor-ID and password in some applications.

When appropriate inventory tracking data has been entered into client software, the preferred inventory management system may transmit such data to a server. A server may send a confirmation message to a client upon receipt of such data. If a confirmation message, is not received within a predetermined period of time, the preferred inventory management system may resend inventory tracking data. If successive resend attempts are unsuccessful, the preferred inventory management system may follow a process similar to that illustrated by FIG. 3. Client software may allow additional inventory scans to occur while waiting for confirmation from a server.

In addition to recording inventory tracking information, client software may also allow a customer to access various options. Such options may include, but are not limited to, an administrative page, an inventory status inquiry page, and an inventory receipt page. An administrative page can allow authorized customers to create, edit, or remove User-ID's, Doctor-ID's, groups of such accounts, and account-specific information. An inventory status inquiry page can retrieve and display a page containing customer inventory records, order status, and other such information.

An inventory status inquiry may be initiated through client software, which can send a page containing customer-specific information, as well as site-specific identification information stored on a client machine. In a preferred embodiment, a server receiving such a request may select records with appropriate site- and user-specific information from a table of customer inventory records. A server may generate a page or screen containing customer inventory information, including information from several tables. Table 1 below provides an example of columns displayed on a typical inventory request screen, as well as sample table and field names from which such data can be drawn.

TABLE 1

| Column Heading | Source Table | Source Field |
|---|---|---|
| Description | PRODUCTS | DESCRIPTION |
| Product | CUSTOMER_INVENTORY | PRODUCT |
| Quantity In Stock | CUSTOMER_INVENTORY | ON_HAND_QTY |
| Order Point | CUSTOMER_INVENTORY | ROP |
| ReOrder Quantity | CUSTOMER_INVENTORY | ROQ |
| Activity Status | CUSTOMER_INVENTORY | STATUS |

An advantage of the preferred inventory management system over the prior art is the ability to simplify adding new items or restocking items into an inventory. Linked Suppliers shipping goods to a customer can provide a specially coded packing list, and a customer can automatically or manually enter such a code into client software. Client software can validate a packing list number as belonging to a customer and ensure a packing list is not credited to a customer system more than once. Entry of an invalid or previously validated packing slip can cause client software to display an error message.

If a valid packing slip is entered, client software may retrieve shipment contents from a centralized database or from a supplier database, and automatically update customer inventory information to reflect inventory received. Client software may then display a message confirming successful inventory changes, and return a customer to a main page.

A product search page may also be accessible through client software. A product search page can allow a user to select a search type and, if appropriate, search parameters and search parameter values (collectively “search criteria”). By way of example, without intending to limit the preferred inventory management system, a product search page may allow a customer to search by specific manufacturer and products of a certain classification.

When a customer has selected appropriate search criteria, client software may pass such search criteria to a server. A server may query a database of products and product descriptions and return products matching or approximating customer search criteria.

If a user has selected a descriptive search, a server may select records from a Products table, or other similar table, whose data matches or approximates descriptive text entered by a user. If a user has selected a parameter search, a server may select Product table records whose fields match or approximate user search requests. To expedite such selections, a server may index descriptions, manufacturers, product classes, product names, and other frequently searched fields.

When appropriate records are selected, a server may transmit such records to client software for display. Client software may present such records in a variety of formats, including, but not limited to, a columnar or tabular format. Table 2 lists sample column names, sample source table names, source field names, and additional functionality client software may present when displaying such records.

TABLE 2

| Column | | |
|---|---|---|
| Heading | Source Table | Source Field |
| Description | PRODUCTS | SHORT_DESCRIPTION |
| Product ID | PRODUCTS | PRODUCT_ID |
| Manufacturer | PRODUCTS | MANUFACTURER |
| Mfg Item No. | PRODUCTS | MANUFACTURER_ITEM_NUMBER |
| Prod. Type | PRODUCTS | PRODUCT_TYPE |
| Prod. Class | PRODUC- | PRODUCT_CLASS |
| | TIONS | |
| Check | None | Window action field |
| Availability | | |
| Add to | None | Window action field |
| Stock Plan | | |

As Table 2 indicates, client software can allow a customer to check product availability and add products to a stock plan. In a preferred embodiment, client software may make such functionality available for each record displayed. In an alternative embodiment, records may have check boxes or other selection controls, thereby allowing customers to check the availability of multiple items, and add multiple items to a stock plan.

When a customer checks availability of a product or products, the preferred inventory management system may search Linked Supplier inventories to determine quantities available, physical location, anticipated delivery times, and the like. When inventory is available, client software may allow a customer to order a product.

When a customer chooses to add a product to an inventory or stocking plan, client software may request restocking and other parameters from a customer, then send appropriate information to a server. A server may add an appropriate entry to a Customer Inventory or other similar table, thereby enabling inventory tracking through the preferred inventory management system.

Client software can also allow a customer to request a telephone call, an E-mail, or other contact from a sales consultant. In a preferred embodiment, a customer may select a product or supplier, and client software can query a server to determine an appropriate sales consultant for the selected product or supplier. A user can then be presented with a dialog box or other interactive interface which asks a customer to confirm a contact request. Once a contact request has been confirmed, client software may cause a server to store a request message in a Contact_Log table or other similar table.

In a preferred embodiment, a server may periodically scan Contact_Log table entries. When new or unanswered requests are found, a server may send a notification to a supplier alerting said supplier of such a request, where such a notification can include a customer E-mail address, telephone number, fax number, or other contact information, as well as other relevant customer and product information.

While the preferred inventory management system can monitor inventory use and automatically order new inventory when necessary, a customer may anticipate a need for additional inventory based on parameters outside the scope of the preferred inventory management system. By way of example, without intending to limit the preferred inventory management system, if the preferred inventory management system is used in a hospital, and the Olympics was held in or near the city in which the hospital is located, a hospital administrator may foresee the need to order additional quantities of frequently used supplies. Client software can provide a customer with the ability to quickly place such orders.

Customers can initiate such an order by clicking a button or otherwise interacting with a graphical or physical interface. In a preferred embodiment, a customer may select from products or groups of products already included in an inventory or stocking plan, or a customer may search for products through an interface similar to that described earlier. As previously described, customers can designate standard restocking quantities, and client software may use such quantities as defaults when clients are requesting additional inventory. Client software may also present quantities on hand to help customers make smarter purchasing decisions. Based on such information, customers can modify order quantities before submitting an order.

Client software can transmit customer orders to a server. Upon receipt of a customer order, a server can initiate an order fulfillment process.

A server may also automatically place an order based on customer demand. A server may periodically scan a customer inventory table and monitor inventory usage. As inventory is depleted, a server can predict frequently used items, and order appropriate quantities. Initially, a server may order limited quantities, to limit customer costs. A server may increase order quantities for frequently ordered products as customer usage habits dictate. A server may also construct an historical usage characterization, so that seasonal or other periodic usage patterns can be automatically taken into account.

As orders are placed, a server can query Linked Supplier inventories to determine each supplier's ability to fulfill an order. A server can calculate shipping costs as each order is processed, and a server can select one or more suppliers who can most cost effectively meet customer needs. As qualified suppliers are identified, orders are placed which can include expedited delivery and other options as specified by a customer or as determined by a server.

A server can also post supplier invoices to an accounts payable system, generate customer invoices based on supplier invoices, post customer invoices to an accounts receivable system. A server may further integrate with an automated payment system, thereby limiting invoicing and other such expenses.

In addition to customer and order related functions, a server can also provide administrative functions. By way of example, without intending to limit the preferred inventory management system, a user who is not a customer can register to be a customer through a server-provided interface. Such an interface may allow a user to specify a business name, business type, executive director or general manager, physical address, mailing address, shipping address, one or more telephone numbers, employee names, employee licensing and accreditation information, and the like.

As users submit such information, a server may validate that an address, telephone number, and zip code are all valid with respect to each other, and that all necessary fields have been filled. If any validations fail, a server may present a data entry page along with any invalid data, thus simplifying data correction.

A server and client software may also allow customers and suppliers to change various information. By way of example, without intending to limit the preferred inventory management system, suppliers can change pricing; add or remove vendors and products; add, edit, or remove contacts; view account status and open invoices; and perform other such functions. Customers can adjust inventory counts to reflect audit results; add, edit, or remove employees and employee information; update payment and contact information; view account balances and make payments; and perform other such functions.

Linked Suppliers can also take advantage of many of these same features. Linked Suppliers implementing the preferred inventory management system can track inventory; provide real-time inventory information to prospective customers; accept electronic orders; generate pick/pack lists; track order fulfillment process, including tracking into which containers each item in an order has been placed; generate bar-coded packing lists and shipping labels for each container; and generate invoices.

The preferred inventory management system also provides Linked Suppliers with other advantages over the prior art. By way of example, without intending to limit the preferred inventory management system, Linked Supplier inventory needs can be forecast based on prior order history, prior lead times, safety stock quantities, and the like, thereby reducing overall inventory investment. The preferred inventory management system can also allow enable a Linked Supplier to track processing and shipping status for various products within an order, thereby providing a higher level of customer service. The preferred inventory management system may also allow managers or other authorized individuals to electronically sign a purchase order, invoice, or other billing or order document and electronically transmit such a document to an appropriate recipient.

To achieve the functionality set forth above, a preferred embodiment of the preferred inventory management system includes the following table structure. The table structure described below is included for enablement and best mode purposes, and should not be construed as limiting the preferred inventory management system.

Table Name

CLIENT CONTROL

Table Description and function—This table can reside locally on a customer computer. It can store one or more records containing control data needed to manage on and off-line functions remotely. These records can be updated via an update applet transferring data from the Web Server's SQL database to this control. Its purpose is to provide control over the processes running on the local machine even if it is off-line, and to enable it to reconnect automatically.

Table Name

CLIENT CONTROL

| Column (field) Name | Description |
|---|---|
| CUSTOMER_ID | Customer ID - matches Customer ID in |
| | CUSTOMERS data in the Web Server SQL Database |
| IP_ADDRESS | This is the IP address for this machine |
| DSL_PORT | Connection path or port (e.g., COM2) where DSL |
| | connection exists; null if there is no DSL line for this |
| | machine |
| DIAL_PORT | Connection path ro port (e.g., COM3) where dial-up |
| | connection exists; null if there is no dial-up connection |
| | for this machine |
| DIAL_CONNECTION_PHONE | Phone number the software dials to establish a dial-up |
| | connection to the Web server system. Null if there is |
| | no dial-up connection |
| DIAL_CALL_BACK | Phone number of the dial-up line; to allow call-back |
| | from the web server. |

Table Description and function—This table contains an error generation history for processes originating on a customer machine. It can provide an audit trail and view of how well processes are functioning, and a place to record both fatal-error conditions and those that may not need to be displayed to customers. Its data may not be processed, but can be stored for review by system administrators and managers.

Table Name

SYSTEM_ERROR+_LOG

| Column (field) | | Field Characteristics |
|---|---|---|
| Name | Description | & Indexing |
| ERROR_DATE | Date of error log entry | Index - |
| | | concatenated with |
| | | ERROR_TIME |
| ERROR_TIME | Time of error log entry | Index - with |
| | | ERROR_DATE |
| CALLER | Program name generating | |
| | the error log entry | |
| ERROR_MESSAGE | Error message generated by | |
| | the caller program | |
| USER_VIEWABLE | Yes - if message also | |
| | displayed on user seen | |
| | page; No if internal only | |
| | message | |
| DATA_DUMP | Data (if any) causing the | |
| | error | |

Table Description and function—This table can contain a history of errors generated by processes originating from outside a customer machine. The table can provide an audit trail and view of how well processes are functioning, and provide a place to record both fatal and non-fatal errors. Such data can allow system administrators, programmers, and managers to monitor automated, unattended processes. SYSTEM_ERROR_LOG can use a data dictionary/field structure similar to a Client_Error_Log table.

Table Name

SYS_PARAMETERS

| Column (field) | | Field Characteristics |
|---|---|---|
| Name | Description | & Indexing |
| ERROR_DATE | Date of error log entry | Index - |
| | | concatenated with |
| | | ERROR_TIME |
| ERROR_TIME | Time of error log entry | Index - with |
| | | ERROR_DATE |
| CALLER | Program name generating | |
| | the error log entry | |
| ERROR_MESSAGE | Error message generated | |
| | by the caller program | |
| USER_VIEWABLE | Yes - if message also | |
| | displayed on user seen | |
| | page; No if internal only | |
| | message | |
| DATA_DUMP | Data (if any) causing the | |
| | error | |

Table Description and function—Stores system-wide parameters in a common table.

Table Name

CUSTOMER APPLICATION

| Column (field) | | |
|---|---|---|
| Name | Description | Field Characteristics & Indexing |
| PARAM_ID | Identifies parameter | Primary Index |
| VAR1 | First variable | |
| VAR2 | Second variable | |
| VAR3 | Third variable | |

Table Description and function—this table can have a data dictionary similar to the CUSTOMERS table, and can be used to temporarily store unapproved, unprocessed customer application data submitted by a Customer/Client Application page. When an application is processed, appropriate records can be deleted from this table.

Table Name

MEMBERS APPLICATION

| | | |
|---|---|---|
| Column (field) | | |
| Name | Description | Field Characteristics & Indexing |

See CUSTOMERS

Table Description and function—this table has may use a data dictionary similar to PRACTICE MEMBERS, and can temporarily store unapproved, unprocessed customer application data submitted by a Customer/Client Application page. When an application is processed, appropriate records can be deleted from this table.

Table Name

CUSTOMERS

| | | |
|---|---|---|
| | | Field |
| Column (field) Name | Description | Characteristics & Indexing |

See
PRACTICE_MEMBERS

Table Description and function—Can store a unique identifier for each customer in a permanent table. Activity logged in CUSTOMER_MAINT_HISTORY table. Can be linked to third-party applications for credit terms, bill to, ship to addresses, phones and other financial data.

Table Name

PRACTICE_MEMBERS

| | | | Field |
|---|---|---|---|
| | | | Characteristics |
| Column (field) Name | Description | Comment | & Indexing |
| CUSTOMER | Identifies | Unique identifier | Primary Index |
| | customer | (account number); | |
| | | matches | |
| | | CUSTOMER in A/R | |
| | | system | |
| NAME | Practice Business | See Practice | Index |
| | Name | Members for doctor | |
| | | data. | |
| SALES_CONSULTANT | Identifies sales | | Index |
| | consultant | | |
| | assigned to | | |
| | account | | |
| IPADDRESS1 | Internet address | Can have multiple | |
| | used to link, | computers in larger | |
| | identify | offices. | |
| | computers in | | |
| | customers office | | |
| IPADDRESS2 | Internet address | Can have multiple | |
| | used to link, | computers in larger | |
| | identify | offices. | |
| | computers in | | |
| | customers office | | |
| IPADDRESS3 | Internet address | Can have multiple | |
| | used to link, | computers in larger | |
| | identify | offices. | |
| | computers in | | |
| | customers office | | |
| IPADDRESS4 | Internet address | Can have multiple | |
| | used to link, | computers in larger | |
| | identify | offices. | |
| | computers in | | |
| | customers office | | |
| DISCOUNT_CODE | Identifies which | Code must be in | Index |
| | discount code is | DISCOUNT_CODES | |
| | used to calculate | table. | |
| | prices charged for | | |
| | this customer | | |
| PHYSICAL_ADDRESS | Street address of | | |
| | practice | | |
| PHYSICAL_STATE | State in which the | | |
| | practice is located | | |
| PHYSICAL_ZIP | Zip code of | | |
| | physical location | | |
| | of practice | | |
| SHIP_TO_ADDRESS | Address to which | | |
| | shipments go | | |
| SHIP_TO_STATE | State for ship to | | |
| | address | | |
| SHIP_TO_ZIP | Zip code for ship | | |
| | to address | | |
| MAIL_ADDRESS | Mailing address | Literature, documents | |
| | (for other than | only (may be a PO | |
| | shipments) | Box to which UPS & | |
| | | FedEx cannot ship) | |
| MAIL_STATE | Mail address state | | |
| MAIL_ZIP | Zip code for mail | | |
| | address | | |
| ADMINISTRATOR | Administrator, | | |
| | manager, etc. of | | |
| | Customer | | |

Table Description and function—This table can be linked to records in a CUSTOMERS table, and can store data pertaining to individual physicians or other health-care professionals working at or with a practice.

Table Name

DISCOUNT_CODES

| | | | Field |
|---|---|---|---|
| | | | Characteristics |
| Column (field) Name | Description | Comment | & Indexing |
| CUSTOMER | Customer to | Must be in | Index - |
| | whom the | CUSTOMERS table | concatenated |
| | Practice Member | already | with |
| | is associated | | MEMBER_NAME |
| MEMBER_NAME | Name of health- | Together with | With |
| | care professional | CUSTOMER, forms | CUSTOMER |
| | or physician | unique record key | |
| | linked to | | |
| | CUSTOMER | | |
| MEMBER_TITLE | Title (e.g., Exec. | | |
| | Director) of | | |
| | member | | |
| MEMBER_MAIL_ADDRESS | Separate mailing | | |
| | address for | | |
| | member | | |
| MEMBER_MAIL_STATE | Member mail | | |
| | address state | | |
| MEMBER_MAIL_ZIP | Member mail | | |
| | address zip | | |
| MEMBER_LICENSE_NO | Professional | | |
| | license for | | |
| | member | | |
| MEMBER_LICENSE_EXPIRE | Expiration Date | | |
| | of member's | | |
| | professional | | |
| | license | | |
| MEMBER_DEGREE1 | First degree of | | |
| | member | | |
| MEMBER_DEGREE2 | Second degree of | | |
| | member | | |
| MEMBER_DEGREE3 | Third degree of | | |
| | member | | |
| MEMBER_DEGREE4 | Fourth degree of | | |
| | member | | |
| MEMBER_NOTES | Text/comment | | |
| | field | | |
| DATE_NEW | Date this member | | |
| | was added to | | |
| | table | | |
| DATE_LAST | Last activity date | | |

Table Description and function—can contain decimal values representing a unique price to be charged or discount to be granted to each customer. Any number of customers may use a discount code. When a decimal value associated with a given code is changed, the result is that all prices for all customers using that code are changed. If a customer's discount code specifies a discount value greater than allowed for a given product, the preferred inventory management system may limit a price to the maximum discount.

Table Name

CUSTOMER INVENTORY

| Column (field) | | | Field Characteristics |
|---|---|---|---|
| Name | Description | Comment | & Indexing |
| DISC_CODE | Discount code | Identifies specific | Primary Index |
| | | discount; numbering | |
| | | should be 10, 20, 30, | |
| | | etc. to allow for | |
| | | insertions in future, e.g, 14 | |
| DISC_VALUE | Decimal value for | | |
| | the discount to be | | |
| | given. | | |
| NOTES | Notes; text field for | | |
| | commentary about a | | |
| | particular discount | | |
| | code | | |

Table Description and function—stores inventory at customer office. One record for each customer/SKU combination, including all that have been used in past, or which are to be used for next ordering cycle. Permanent table. Activity logged in CUSTOMER_INVENTORY_TX table.

Table Name

PRODUCTS

| Column (field) | | | Field Characteristics |
|---|---|---|---|
| Name | Description | Comment | & Indexing |
| CUSTOMER | Identifies customer | | Index - |
| | | | concatenated with |
| | | | PRODUCT |
| PRODUCT | Identifies product at | | Indexed with |
| | customer's site | | CUSTOMER |
| ON_HAND_QTY | Quantity of an item | | |
| | on hand at this | | |
| | customer | | |
| ROP | Reorder point | When on_hand_qty | |
| | quantity | falls to or below this | |
| | | quantity, a new | |
| | | order is triggered for | |
| | | the product. | |
| ROQ | Quantity to be | Ordering process | |
| | ordered | uses this quantity | |
| | | when a product is | |
| | | “triggered” | |
| STATUS | Activity status of | Values: | Index |
| | item | Active (default, | |
| | | normal setting) | |
| | | NoOrder (continue | |
| | | to use up inventory, | |
| | | but no more orders) | |
| | | NoUse (do not | |
| | | accept scanned | |
| | | usage of product) | |

Table Description and function—identifies products available for sale at any point in time. Includes products no longer active. One record for each product/SKU/Item Number.

Table Name

MANUFACTURERS

| | | | Field Characteristics |
|---|---|---|---|
| Column (field) Name | Description | Comment | & Indexing |
| PRODUCT_ID | Identifies | | Primary Index |
| | product; SKU; | | |
| | also is “item | | |
| | number” | | |
| SHORT_DESCRIPTION | Short description | | Index |
| | appearing on | | |
| | most printed | | |
| | outputs & | | |
| | screens | | |
| LONG_DESCRIPTION | Long description | | Index, built so each |
| | for additional | | word is indexed |
| | description | | separately. |
| MANUFACTURER | Company | | Index |
| | making product; | | |
| | Must be in | | |
| | MANUFACTURERS | | |
| | table | | |
| MANUFACTURER_ITEM_NUMBER | Manufacturer's | | Index |
| | product identifier | | |
| STATUS | Item status | Values: | |
| | | Active (default, | |
| | | normal usage) | |
| | | NoOrder (accept | |
| | | usage scans, no | |
| | | orders) | |
| | | NoUse (do not | |
| | | accept usage scans; | |
| | | no activity; obsolete | |
| | | or discontinued) | |
| PRODUCT_CLASS | Marketing/sales | | Index |
| | classification of | | |
| | product | | |
| PRODUCT_GROUP | Commodity | | Index |
| | classification of | | |
| | product | | |
| PRODUCT_LINE | Financial | | Index |
| | reporting | | |
| | classification of | | |
| | product | | |
| SELL_START_DATE | Date that new | Prior to this date | |
| | orders for this | orders will not be | |
| | product can be | processed (new | |
| | processed | product so not | |
| | | available yet) | |
| SELL_END_DATE | Date after which | After or on this date, | |
| | new orders for | orders will not be | |
| | this product | processed | |
| | cannot be | (discontinued | |
| | processed | product) | |
| PRODUCT_PICTURE | Product Picture | JPEG or GIF | |
| | bit map image | | |

Table Description and function—This table stores all manufacturers whose products may be carried in the PRODUCTS table. It serves as a reference and validation table for products.

Table Name

ORDERS

| Column (field) | | | Field Characteristics & |
|---|---|---|---|
| Name | Description | Comment | Indexing |
| MANUFACTURER_ID | Short abbreviation | | Primary Index |
| | for manufacturer | | |
| MANUFACTURER_NAME | Normal business | | Indexed |
| | name for | | |
| | manufacturer | | |
| DATE_ADDED | Date this | | |
| | Manufacturer was | | |
| | added to the table | | |

Table Description and function—stores orders generated by nightly process and/or by critical ordering process, which are then downloaded to distributor. Serves as order “Header” record. Linked to ORDER DETAIL table where line items are stored. No maintenance history log table. One record for each order generated and downloaded.

Table Name

ORDER DETAIL

| Column (field) | | | Field Characteristics |
|---|---|---|---|
| Name | Description | Comment | & Indexing |
| ORDER_NO | Order Number; | Generated by | Primary Index |
| | unique identifier for | ordering processes; | |
| | the order | increments | |
| | | SYSTEM_PARAMTER | |
| | | for order | |
| | | number | |
| ORDER_DATE | Date order | | Index |
| | generated | | |
| ORDER_TIME | Time order | | |
| | generated | | |
| ORDER_SOURCE | How order was | Sources are: | |
| | generated | AUTO - nightly | |
| | | process | |
| | | MANUAL - | |
| | | manual order | |
| | | entered on terminal | |
| | | in customer's office. | |
| CUSTOMER | Customer on the | | Index |
| | order | | |
| LINKED_SUPPLIER | Linked Supplier to | | Index |
| | whom the order was | | |
| | downloaded | | |
| ORDER_STATUS | Status of the order; | Values: | Index |
| | shows latest status | GEN - generated | |
| | only, sequence is | PLACED - | |
| | presumed | downloaded to | |
| | | supplier | |
| | | S_BILLED - | |
| | | supplier has | |
| | | invoiced Med-e- | |
| | | Track | |
| | | C_BILLED - | |
| | | system has | |
| | | converted supplier | |
| | | invoice to customer | |
| | | invoices | |
| STATUS_DATE | Date which status | | |
| | changed | | |
| SHIP_TO_ADDRESS | Address to which | | |
| | orders is to be | | |
| | shipped; appears on | | |
| | downloaded order | | |
| | data | | |
| ORDER_PRODUCT_TOTAL | Total value of order | | |
| | for product only; not | | |
| | including tax, | | |
| | shipping, other | | |
| | charges | | |

Table Description and function—stores line item detail on ORDERS. One record for each line item on an order.

Table Name

LINKED SUPPLIER

| | | | Field |
|---|---|---|---|
| | | | Characteristics & |
| Column (field) Name | Description | Comment | Indexing |
| ORDER_DTL_ORDER_NO | Order number to | | Index - |
| | which this detail | | concatenated with |
| | record belongs | | ORDER_LINE_NUMBER |
| ORDER_LINE_NUMBER | Line number for | With | |
| | order. | Order_Dtl_Order_no, | |
| | | forms | |
| | | a unique | |
| | | identifier | |
| PRODUCT | Product identifier | | Index |
| | for item ordered | | |
| ORDER_QUANTITY | Quantity of the | | |
| | product that is | | |
| | being ordered. | | |
| SHIP_QUANTITY | Quantity of the | | |
| | item shipped; as | | |
| | reflected on an | | |
| | uploaded, | | |
| | processed | | |
| | supplier | | |
| | invoice/packlist | | |
| CUSTOMER_UNIT_PRICE | Price to be | | |
| | charged to | | |
| | customer | | |
| CUSTOMER_UNI_SALES_TAX | Sales tax, if any | | |
| | to be charged | | |
| | customer | | |
| PRODUCT_ORDERED_SUBTOTAL | Value = Order_Quantity * | | |
| | Customer_Unit_price | | |
| PRODUCT_SHIP_SUBTOTAL | Value = Ship_Quantity * | | |
| | Customer Unit_Price | | |
| LINKED_SUPPLIER_UNIT_COST | Price to be paid | | |
| | Linked Supplier | | |
| | for this item | | |
| LINKED_SUPPLIER_PRODUCT_SHIP_SUBTOTAL | Value = Ship_Quantity * | | |
| | Linked_Supplier_Unit_cost | | |

Table Description and function—Stores and sets up each linked supplier, i.e., distributor that is linked into the web site. One record for each supplier that will be, is now, or has been linked at one time into Med-e-Track. Activity logged in LINKED_SUPPLIER MAINT_HISTORY. Account is linked to Supplier table in the SOLOMAN Accounts Payable subsystem.

Table Name

SUPPLIER INVOICE

| Column (field) Name | Description | Comment |
|---|---|---|
| SUPPLIER | Supplier's ID | Unique identifier |
| SUPPLIER_IP_ADDRESS | IP Address where | |
| | linking process occurs | |
| OPEN_DATE | Date the relationship | |
| | was setup/started | |

Table Description and function—stores uploaded invoice/pack lists from linked suppliers. Serves as “header” record for invoices. A given Order can have multiple invoices. Linked to SUPPLIER INVOICE DETAIL records which carry line item detail. Invoices uploaded from distributor reflect orders they have shipped and are then used to generate Customer invoices. The uploaded invoice data is also transferred to the Accounts Payable module of the. Solomon IV software for corporate accounting/tracking. Customer invoices generated and recorded in this table are also transferred to the Accounts Receivable module.

Table Name

INTERNAL_INVOICE_SHIP_DETAIL

| Column (field) | | | Field Characteristics |
|---|---|---|---|
| Name | Description | Comment | & Indexing |
| INTERNAL_INVOICE_ID | Internal, system | Insures unique | |
| | generated invoice | invoice | |
| | identifier | identification in | |
| | | case of similar | |
| | | supplier invoicing | |
| | | schemes/numbers | |
| ORDER | Order number | | |
| | which the invoice is | | |
| | a shipment/bill for. | | |
| SUPPLIER_INVOICE | Invoice identifier | Uploaded invoice | |
| | from supplier | data | |
| SUPPLIER_INVOICE_DATE | Date of/on supplier | | |
| | invoice that was | | |
| | uploaded | | |
| SUPPLIER_INVOICE_TIME | Time that supplier | Invoice time may | |
| | invoice was | not appear in | |
| | uploaded | supplier database. | |
| AP_DATE | Date supplier | | |
| | invoice data posted | | |
| | to AP tables | | |
| AP_TIME | Time supplier | | |
| | invoice data was | | |
| | posted to AP tables | | |
| CUSTOMER_INVOICE | Invoice ID | Presence indicates | |
| | generated by nightly | that nightly process | |
| | process to bill | has run, generating | |
| | customer for | this separate invoice | |
| | shipment | number. | |
| CUSTOMER_INVOICE_DATE | Date customer | | |
| | invoice generated | | |
| | by nightly process | | |
| CUSTOMER_INVOICE_TIME | Time of customer | | |
| | invoice generation | | |
| | process. | | |
| AR_DATE | Time | | |
| SHIPMENT | Shipment document | May be separate ID | Index on this field |
| | number | from invoice no. | for packing slip data |
| | | | retrieval. |
| SHIP_VIA | Shipping method; | | |
| | e.g., UPS Ground | | |

Table Description and function—This table contains shipment information for the shipment covered by the Internal Invoice. There is one record for each carton comprising the shipment covered by the Invoice. It is linked to the Internal Invoice table.

Table Name

SUPPLIER_INVOICE_DETAIL

| Column (field) Name | Comment |
|---|---|
| INTERNAL_INVOICE_ID | |
| SHIP_CARTON_ID | Together with invoice id, |
| | comprises unique record ID |
| TRACKER_NO | |

Table Description and function—this table carries the line item level detail for invoices uploaded from the linked supplier/distributor. Some line item level detail is used to update Order data to support quick order status inquiries and track back-ordered items.

Table Name

SUPPLIER_COST

| Column (field) Name | Description | Comment |
|---|---|---|
| INTERNAL_INVOICE_ID | Identifier for internal | |
| | invoice no | |
| INTERNAL_INVOICE_LINE_NUMBER | Line number for internal | Together with Internal |
| | invoice | Invoice identifier, forms |
| | | unique key |
| SHIPPED_PRODUCT | Product shipped | |
| SHIP_QUANTITY | Quantity shipped | |
| UNIT_PRICE | Supplier's Unit price | |
| UNIT_TAX | Sales Tax (if any) | |
| EXTENDED_PRICE | Value = Ship_qty * | Product only subtotal |
| | Unit_Price | |
| LINE_TAX_TOTAL | Value = Ship_Qty * | |
| | Unit_Tax | |
| LINE_TOTAL_AMOUNT | EXTENDED_PRICE + | |
| | Line_Tax_total | |

Table Name

SUPPLIER_COST

Table Description and function—Stores prices to be paid to each Linked Supplier in the system. One record for each linked supplier and SKU. Permanent table. Activity logged in SUPPLIER_COST_MAINT_HISTORY table.

| | | | |
|---|---|---|---|
| Column (field) | Description | Comment | Field Characteristics |
| Name | | | & Indexing |

Table Name

SUPPLIER_COST_MAINT_HISTORY

Table Description and function—records changes made to SUPPLIER_COST records. One record for each field changed during an update of a given record.

| | | | |
|---|---|---|---|
| Column (field) | Description | Comment | Field Characteristics |
| Name | | | & Indexing |

Table Name

PRODUCT_MAINT_HISTORY

Table Description and function—records changes made to PRODUCTS table. One record for each field changed during an update of a given record.

| | | | |
|---|---|---|---|
| Column (field) | Description | Comment | Field Characteristics |
| Name | | | & Indexing |

Table Name

PRODUCT CLASS

Table Description and function—Identifies valid product classes; serves as a reference table.

| Column (field) Name | Description |
|---|---|
| PROD_CLASS_CODE | Code for product class description |
| DESCRIPTION | Text/descriptive name for product_class code |

Table Name

PRODUCT GROUP

Table Description and function—Identifies valid product groups; serves as a reference table.

| Column (field) Name | Description |
|---|---|
| PRODUCT_GROUP_CODE | Code for product group description |
| DESCRIPTION | Text/descriptive name for Product |
| | Group Code. |

Table Name

PRODUCT_LINE

Table Description and function—Identifies valid product lines; serves as a reference table.

| Column (field) Name | Description |
|---|---|
| PRODUCT_LINE_CODE | Code for product line description |
| DESCRIPION | Text/descriptive name for product line |
| | code |

Table Name

CUSTOMER INVENTORY TRANSACTIONS

Table Description and function—transaction history table for activity altering data in Customer Inventory table; one record for each change recorded; main use will be recording inventory activity, although transactions will be generated for changes to status, ROP, ROQ and Notes values, i.e., non-on-hand quantity values. Each transaction affects only one data field. Transaction code indicates what update/change activity was performed, and therefore which data field was updated.

| Column (field) | | |
|---|---|---|
| Name | Description | Comment |
| TRAN_NO | Unique identifier for each | Functions |
| | transaction; non significant | like a check |
| | | number. |
| TRAN_DATE | Date transaction processed | |
| TRAN_TIME | Time transaction processed | |
| TRAN_ID | Code identifying transaction | Values: |
| | | TBD |
| PRODUCT | Product identifier of item | |
| | affected | |
| QTY | | |
| CUSTOMER | Customer whose inventory data | |
| | was updated/changed | |
| USER_ID | User performing transaction | |
| BEFORE_VALUE | Value of data field prior to | |
| | update action | |
| AFTER_VALUE | Value of data field after update | |
| | action | |

Table Description and function—this table accepts transactions from the consultant request function, enters and tracks them for follow-up and management purposes.

| Column (field) Name | Description |
|---|---|
| SALES_CONSULTANT_ID | ID in Sales_Consultants table. |
| REQUEST_DATE | Date customer initiated request |
| REQUEST_TIME | Time customer initiated request |

Table Description and function—This table stores information about each user at a customer's site. There are two classes of users, supervisor and staff. Only a user with supervisor rights can add new users. The web page “Hard-wires” who the customer is so customer users are kept associated with the correct customer.

| | | | |
|---|---|---|---|
| Column (field) | Description | Comment | Field Characteristics |
| Name | | | & Indexing |

Table Description and function—This table stores data about each Sales Consultant. It is essentially a reference table.

| Column (field) Name | Description |
|---|---|
| SALES_CONSULTANT_ID | Unique identifier * record key |
| CONSULANT_SHORT_NAME | Short name, nicknemame, |
| | initials to be used |
| | on screens, reports |
| CONSULTANT_FULL_FIRST_NAME | First name of consultant |
| CONSULTANT_LAST_NAME | Last name of consultant |

It should be obvious to one skilled in the art that the preferred inventory management system allows inventory tracking and management through a combination of manual, semi-automated, and automated means. The preferred inventory management system also allows a manager to purchase in bulk and take advantage of promotions and other special offerings, thus reducing inventory costs. In addition, the preferred inventory management system reduces the amount of inventory which must be kept on-hand by accurately modeling and predicting inventory needs. The preferred inventory management system further provides customers with the ability to review new equipment, communicate with each other, and buy and sell excess inventory, refurbished equipment, and the like.

While the preferred embodiment and various alternative embodiments of the preferred inventory management system have been disclosed and described in detail herein, it may be apparent to those skilled in the art that various changes in form and detail may be made therein without departing from the spirit and scope thereof, including applying the preferred inventory management system to fields other than healthcare.

Thus, the preferred inventory management relates to an inventory management system comprising:

one or more computers;

one or more databases residing on said computers, in which inventory information is stored;

client software providing an interface to said database and performing administrative functions;

a user identification subsystem;
a first subsystem, through which new products can be added to said database, and which enables proper accounting of restocked products within said database; and
a second subsystem, which accounts for products within said database as such products are removed from inventory;
a third subsystem, wherein the third subsystem allows at least one vendor to access the database; and
a fourth subsystem, wherein the fourth subsystem allows for automated product identity data entry.

In one aspect of the preferred inventory management system, said one or more of said subsystems are comprised of an optical reader which can read specially coded information on an object or person.

In another aspect of the preferred inventory management system, said one or more of said subsystems are comprised of an electronic device for scanning wirelessly accessible-identifiers associated with objects or persons.

In an alternate aspect of the preferred inventory management system, said user identification subsystem is comprised of a biometric identification device.

In a further aspect of the preferred inventory management system, said client software permits registration and removal of individual users, and modification of user information.

In another aspect of the preferred inventory management system, said client software allows users to be classified into groups, and where permissions or roles are assigned to such groups.

In yet another aspect of the preferred inventory management system, said client software allows products to be grouped, allows restrictions to be placed on distribution of such products, permits recording of information when a product belonging to a group is dispensed, and allows printing of product specific or group specific information for inclusion with each product removed from inventory.

In an alternate aspect of the preferred inventory management system, said client software monitors inventory levels and reports anticipated shortages.

In a further aspect of the preferred inventory management system, said client software monitors inventory levels and generates orders to cover anticipated shortages.

In yet a further aspect of the preferred inventory management system, said client software allows users to order new products or to supplement inventory when desired.

In another of the preferred inventory management system, said client software allows users to specify a price for goods for sale within an inventory.

The preferred inventory management further relates to a vendor managed inventory system, comprising: one or more suppliers maintaining inventory utilizing an inventory management system; one or more customers maintaining inventory utilizing an inventory management system; a central server, which facilitates communications and inventory management between said customers and said suppliers; and, a redundant data connection between said suppliers, said customers, and said central server.

In one aspect of the preferred inventory management system, said central server receives inventory information from customers and suppliers, anticipates inventory shortages, generates orders to cover such shortages, selects suppliers and products for such orders, places orders with selected suppliers, and monitors order status.

The preferred inventory management additionally relates to an inventory distribution system comprising: a vending machine; a computer connected to said vending machine; software running on said computer; a printer; a user identification subsystem; and a data entry subsystem.

In one aspect of the preferred inventory management system, said user identification subsystem is comprised of a biometric scanner, RFID reader, barcode scanner, keyboard, touch sensitive display, or combinations thereof, and through which users can positively identify themselves to said computer via said software.

In another aspect of the preferred inventory management system, said data entry subsystem is comprised of an active or passive user interface, and through which users can request dispensation of certain products.

In a further aspect of the preferred inventory management system, said printer prints product information when requested and as necessary to satisfy applicable regulations.

In an alternate aspect of the preferred inventory management system, said inventory distribution system further comprises a central server and a redundant data connection between said vending machine and said server.

In a preferred embodiment, said computer monitors distribution of products contained within said vending machine, transmits such distributions to said server via said redundant data connection, and through which said server can notify a vending machine service provider of any inventory shortages.

The preferred inventory management also relates to an automated method of inventory management involving the steps of: accounting for received products in an inventory; monitoring products as such products are removed from an inventory; calculating trends based on the frequency with which products are used; determining optimal product quantities for each order, such that shipping costs are reduced and price points for different quantities are taken into account while also reducing expenditures. Ordering additional stock as needed; tracking said orders; calculating order fulfillment trends based on delivery times from each supplier and for each product; and, determining preferred suppliers based on such order fulfillment trends.

In one aspect of the preferred inventory management system, said step of accounting for received products in an inventory involves electronically reading documentation supplied with each package and automatically updating inventory information to reflect package contents.

In another aspect of the preferred inventory management system, said step of monitoring products as such products are removed from an inventory involves electronically reading a product identifier associated with a product or group of products.

In a further aspect of the preferred inventory management system, said automated inventory management method further includes the step of identifying a user removing products from an inventory by electronically retrieving an identifier from said user.

In addition, the preferred inventory management relates to an automated order fulfillment method, comprising the steps of: receiving an availability and pricing request from a customer for one or more products; determining acceptable alternatives for said products based on customer preferences; determining quantities available, pricing, quantities necessary for a price break, and anticipated delivery times from one or more suppliers to meet said request, including any acceptable alternatives; selecting products, product quantities, and suppliers that provide the most value while still meeting customer inventory needs; generating product pick and pack slips for each supplier; recording products as they are “picked” from a supplier inventory; recording products as they are packed into shipping packages; generating package packing slips and shipping labels; correlating shipping and packing information; shipping said packages; and tracking said shipments.

In one aspect of the preferred inventory management system, said picked products are recorded by electronically scanning identifiers associated with such products.

In a preferred embodiment, said picked products are recorded by electronically scanning identifiers associated with such products using a handheld computing device, to which a barcode scanner is attached.

In another aspect of the preferred inventory management system, said step of recording products as they are packed further includes the step of scanning an identifier associated with a shipping package prior to scanning individual items packed into a shipping package.

In a further aspect of the preferred inventory management system, said packing and shipping labels include a machine readable identifier.

The preferred inventory management further relates to a vendor managed inventory and group purchasing system, comprising: one or more servers; one or more databases running on said servers; client software running on one or more computers at a customer site, which is capable of monitoring customer inventories and reporting such information to said server via a redundant data communications connection; client software running on one or more computers at a supplier site, which is capable of monitoring product quantities on hand and supports multiple product prices depending on order quantities, and which is capable of transmitting such information to said server via a redundant data communications connection; and software running on said server that consolidates customer orders such that customer costs may be decreased by leveraging the consolidated order quantities.

The contents of the complete disclosure of U.S. patent application Ser. No. 10/624,872 is hereby incorporated by reference in its entirety. The contents of Bryan, et al., ‘Fingerprinting’ Documents and Packaging, Nature, 436:435 (2005) is hereby incorporated by reference in its entirety.

The inventive subject matter being thus described, it will be obvious that the same may be modified or varied in many ways. Such modifications and variations are not to be regarded as a departure from the spirit and scope of the inventive subject matter and all such modifications and variations are intended to be included within the scope of the inventive subject matter as described herein.

We claim:

1. A method for tracking, authenticating, or tracking and authenticating an object through a chain of custody, comprising the steps of:
(a) providing a database having client software and residing on at least one storage medium in at least one computer;
(b) collecting and storing in said database at least the following data:
(i) information relating to said object,
(ii) information associating said object to an identifier code which is unique to said object, and
(iii) information relating to user permissions or roles permitting a user to have access to some or all of the information in said database;
(c) providing a system for detecting said unique identifier code at multiple locations in said chain of custody;
(d) tracking said object in said database by detecting said unique identifier code at each time event in which said object is transferred from one party in the chain of custody to another, or from one location in the chain of custody to another, and collecting and storing the identity of each party who takes custody of said object at each time event; and
(e) providing access to information establishing the chain of custody of said object.

2. The method of claim 1, further comprising collecting and storing the identity of each said party who relinquishes custody of said object at each time event.

3. The method of claim 1, further comprising collecting and storing the location of each transfer of custody of said object at each time event.

4. The method of claim 1, further comprising the steps of: collecting and storing in said database information relating to the quantity of objects of a particular type; and aggregating said tracking data for a plurality of objects of a particular type.

5. The method of claim 1, further comprising packaging a plurality of objects into a first-level package and marking said first-level package with a unique first-level package identifier; and tracking said unique first-level package identifier instead of or in addition to said object identifier.

6. The method of claim 5, further comprising packaging a plurality of first-level packages into a second-level package and marking said second-level package with a unique second-level package identifier; and tracking said unique second-level package identifier instead of or in addition to said object identifier and/or said first-level package identifier.

7. The method of claim 1, wherein said unique identifier code is assigned by the original source of said object.

8. The method of claim 1, wherein said unique identifier code is assigned an associated expiration date.

9. The method of claim 1, wherein access to information establishing the chain of custody of said object is provided by generating a chain of custody report.

10. The method of claim 1, wherein access to information establishing the chain of custody of said object is provided by generating one or more alert notifications.

11. The method of claim 10, wherein said one or more alert notifications is selected from the group consisting of an unauthorized party or user alert notification, an unauthorized location alert notification, an excess quantity alert notification, an insufficient quantity alert notification, a past expiration date alert notification, and combinations thereof.

12. A system for tracking, authenticating, or tracking and authenticating an object through a chain of custody, comprising the following elements, operably connected:
(a) a computer having a storage medium;
(b) a database residing on said storage medium, in which at least the following data is stored:
information relating to said object,
information associating said object to an identifier code which is unique to said object, and
information relating to user permissions or roles permitting a user to have access to some or all of the information in said database;
(c) client software residing on said storage medium which provides an interface to said database, wherein:
(i) said client software identifies users and allows users to be classified into groups, and wherein permissions or roles are assigned to such groups,
(ii) said client software tracks said object in said system by detecting said unique identifier code at each time event in which said object is transferred from one party in the chain of custody to another, or from one location in the chain of custody to another, and collects and stores the identity of each party who takes custody of said object at each time event, and
(iii) said client software provides access to information establishing the chain of custody of said object.

13. The system of claim 12, wherein said client software further collects and stores the identity of each said party who relinquishes custody of said object at each time event.

14. The system of claim 12, wherein said client software further collects and stores the location of each transfer of custody of said object at each time event.

15. The system of claim 12, wherein said client software further collects and stores in said database information relating to the quantity of objects of a particular type; and aggregates said tracking data for a plurality of objects of a particular type.

16. The system of claim 12, wherein said unique identifier is selected from the group consisting of said object identifier, a unique first-level package identifier marking a plurality of objects packaged into a first-level package, a unique second-level package identifier marking a plurality of first-level packages, and higher-level unique package identifier marking a plurality of lower-level packages, wherein a new package level encompasses a plurality of packages from the preceding package level.

17. The system of claim 12, wherein said unique identifier code is assigned by the original source of said object.

18. The system of claim 12, wherein said unique identifier code is assigned an associated expiration date.

19. The system of claim 12, wherein access to information establishing the chain of custody of said object is provided by said client software generating a chain of custody report.

20. The system of claim 12, wherein access to information establishing the chain of custody of said object is provided by said client software generating one or more alert notifications.

21. The system of claim 20, wherein said one or more alert notifications is selected from the group consisting of an unauthorized party or user alert notification, an unauthorized location alert notification, an excess quantity alert notification, an insufficient quantity alert notification, a past expiration date alert notification, and combinations thereof.
